(19) United States
(12) Patent Application Publication
(10) Pub. No.: US 2021/0243418 A1
(43) Pub. Date: Aug. 5, 2021

(54) 360 DEGREE MULTI-VIEWPORT SYSTEM

(71) Applicant: PCMS Holdings, Inc., Wilmington, DE (US)

(72) Inventor: Pasi Sakari Ojala, Kirkkonummi (FI)

(21) Appl. No.: 17/049,917

(22) PCT Filed: Apr. 17, 2019
(86) PCT No.: PCT/US2019/027846

§ 371 Date: Oct. 22, 2020

Related U.S. Application Data
(60) Provisional application No. 62/663,915, filed on Apr. 27, 2018.

(51) Int. Cl. H04N 13/117; H04N 13/178; H04N 13/398; H04N 13/366; H04N 13/189

(52) U.S. Cl. CPC H04N 13/117; H04N 13/178; H04N 13/189; H04N 13/366; H04N 13/398

(57) ABSTRACT

Some embodiments of a method may include: receiving metadata indicating which portion of an immersive video corresponds to a first viewport of the immersive video displayed on a first display; tracking an orientation of a second display relative to the first display; determining a second viewport of the immersive video synchronized in time and orientation relative to the immersive video displayed on the first display based on the metadata and the orientation of the second display relative to the first display; and displaying the second viewport on the second display.

### CROSS-REFERENCE TO RELATED APPLICATIONS

The present application is a non-provisional filing of, and claims benefit under 35 U.S.C. § 119(e) from, U.S. Provisional Patent Application Ser. No. 62/663,915, entitled “360 Multi-View Story Telling,” filed Apr. 27, 2018, which is hereby incorporated by reference in its entirety.

### BACKGROUND

360-degree videos are gaining popularity. The content is getting easier to produce with consumer-grade recording devices. Many high-end devices consisting of multi-camera setups support high definition video streams, enabling new user experiences. Many social media and content providers offer 360-degree media content that the user is able to consume with augmented reality devices or by swiping and rotating the view on the screen. For example, there are virtual traveling services and VR-based 360-degree theaters with synchronized headsets, such as the ones described on the website What Can You Do in AltspaceVR?, ALTVR, www<dot>altvr.com/what-can-you-do-in-altspacevr/(last visited Apr. 20, 2018).

360-degree content may be downloaded or streamed to a receiver as a composition of several camera views and a multi-microphone spatial audio stream. The media player may create a 2D view for a stereoscopic headset or a 2D display. The user may move along with a camera recording device set up and observe the surroundings interactively.

### SUMMARY

An example method in accordance with some embodiments may include: receiving metadata indicating which portion of a 360-degree video corresponds to a first viewport of the 360-degree video displayed on a fixed display; tracking an orientation of a mobile device relative to the fixed display; determining a second viewport of the 360-degree video synchronized in time and orientation relative to the 360-degree video displayed on the fixed display based on the metadata and the orientation of the mobile device relative to the fixed display; and displaying the second viewport on the mobile device.

In some embodiments of the example method, determining the second viewport may include: determining a first angle from the orientation of the mobile device relative to the fixed display; determining a second angle from a center of the first viewport of the 360-degree video displayed on the fixed display; and orienting, for the second angle, the 360-degree video synchronized in time and space to generate the second viewport.

In some embodiments of the example method, determining the second viewport of the 360-degree video may include determining a virtual mirror viewport of the 360-degree video.

In some embodiments of the example method, determining the second viewport of the 360-degree video may include selecting a location of a virtual mirror corresponding to a portion of the 360-degree video displayed on the fixed display.

In some embodiments of the example method, displaying the second viewport of the 360-degree video may include rendering a portion of the 360-degree video corresponding to the location of the virtual mirror.

Some embodiments of the example method may further include: recording an image from a front-facing camera of a mobile device to generate a recorded image; and overlaying the recorded image on the second viewport to generate an updated second viewport, wherein displaying the second viewport displays the updated second viewport.

Some embodiments of the example method may further include: recording an image from a front-facing camera of a mobile device to generate a recorded image; and displaying the recorded image as an overlay over the second viewport on the mobile device.

In some embodiments of the example method, the second viewport is a virtual mirror of the first viewport.

Some embodiments of the example method may further include: selecting an object within the second viewport of the 360-degree video as a virtual mirror object, wherein displaying the second viewport may include replacing the virtual mirror object with a portion of the first viewport of the 360-degree video.

Some embodiments of the example method may further include: selecting an object within the 360-degree video as a virtual mirror object; and replacing the virtual mirror object with a portion of the first viewport of the 360-degree video, wherein displaying the second viewport may include displaying the virtual mirror object replaced with the portion of the first viewport of the 360-degree video.

In some embodiments of the example method, the second viewport is a virtual mirror of the first viewport.

Some embodiments of the example method may further include: recording an image from a front-facing camera of a mobile device to generate a recorded image; determining a boundary of a user in the recorded image to generate a shape of the user; cropping the recorded image by tracing the shape of the user to generate a cropped image; and displaying the cropped image as an overlay over the second viewport on the mobile device.

In some embodiments of the example method, determining the second viewport of the 360-degree video may include: capturing an image of the 360-degree video displayed on the fixed display to generate a captured image; determining a first time instant that the captured image is captured; determining a second time instant that a first portion of the 360-degree video corresponding to the captured image is displayed; determining a time delay as the difference between the first time instant and the second time instant; time-adjusting the second viewport based on the time delay to generate a time-adjusted viewport; and displaying the time-adjusted viewport on the mobile device.

In some embodiments of the example method, tracking the orientation of the mobile device relative to the fixed display may include: determining a first direction of the mobile device when the fixed display is parallel to the mobile device at a first time; determining a second direction of the mobile device at a second time; determining a heading difference between the first direction and the second direction; and storing the heading difference as the orientation of the mobile device relative to the fixed display.

In some embodiments of the example method, tracking the orientation of the mobile device relative to the fixed display may include: determining a first direction of the mobile device relative to the fixed display at a first time; determining a second direction of the mobile device relative to the fixed display at a second time; determining a heading difference between the first direction and the second direction; and storing the heading difference as the orientation of the mobile device relative to the fixed display.

In some embodiments of the example method, metadata may include a media presentation description file.

An example apparatus in accordance with some embodiments may include: a processor; and a non-transitory computer-readable medium storing instructions that are operative, when executed by the processor, to perform any of the methods listed above.

Another example method in accordance with some embodiments may include: receiving an immersive video displayed with a first viewport on a first display; receiving metadata indicating the first viewport of the immersive video; tracking a relative orientation between the first display and a second display; synchronizing an orientation of a second viewport of the immersive video relative to the first viewport to generate a synchronized immersive video for the second viewport; determining a modified viewport of the synchronized immersive video based on the first viewport and the relative orientation; and displaying the modified viewport on the second display.

In some embodiments of the example method, tracking the relative orientation between the first display and the second display may include: determining a first direction of the second display relative to the first display at a first time; determining a second direction of the second display relative to the first display at a second time; determining a heading difference between the first direction and the second direction; and storing the heading difference as the relative orientation between the first display and the second display.

In some embodiments of the example method, determining the modified viewport of the immersive video may include selecting a location of a virtual mirror corresponding to a portion of the immersive video displayed on the first display.

In some embodiments of the example method, displaying the modified viewport of the immersive video may include rendering the portion of the immersive video corresponding to the location of the virtual mirror.

An example apparatus in accordance with some embodiments may include: a processor; and a non-transitory computer-readable medium storing instructions that are operative, when executed by the processor, to perform any of the methods listed above.

A further example method in accordance with some embodiments may include: receiving metadata indicating which portion of an immersive video corresponds to a first viewport of the immersive video displayed on a first display; tracking an orientation of a second display relative to the first display; determining a second viewport of the immersive video synchronized in time and orientation relative to the immersive video displayed on the first display based on the metadata and the orientation of the second display relative to the first display; and displaying the second viewport on the second display.

An example apparatus in accordance with some embodiments may include: a processor; and a non-transitory computer-readable medium storing instructions that are operative, when executed by the processor, to perform any of the methods listed above.

### BRIEF DESCRIPTION OF THE DRAWINGS

FIG. 1A is a system diagram of an example system illustrating an example communications system according to some embodiments.

FIG. 1B is a system diagram of an example system illustrating an example wireless transmit/receive unit (WTRU) that may be used within the communications system illustrated in FIG. 1A according to some embodiments.

FIG. 2A is a schematic illustration showing an example video camera for recording an immersive video according to some embodiments.

FIG. 2B is a schematic illustration showing an example viewport for viewing an immersive video according to some embodiments.

FIG. 3 is a system diagram illustrating an example set of interfaces for viewing immersive video on multiple mobile devices according to some embodiments.

FIG. 4 is a flowchart illustrating an example process for creating video and metadata content for an immersive video stream according to some embodiments.

FIG. 5 is a schematic perspective view illustrating an example panel of an immersive video with an indication of a director's designated point of view according to some embodiments.

FIG. 6 is a structure block diagram showing an example segmentation of an immersive video according to some embodiments.

FIG. 7 is a schematic perspective view illustrating an example synchronization of content between two displays according to some embodiments.

FIG. 8 is a schematic perspective view illustrating an example synchronization of a TV display and two mobile devices according to some embodiments.

FIGS. 9A-9C are schematic plan views illustrating an example method for determining content and mobile device viewport orientations relative to scene and other geometry according to some embodiments.

FIG. 10 is a message sequencing diagram illustrating an example process for exploration of immersive video content with a virtual mirror according to some embodiments.

FIG. 11 is a message sequencing diagram illustrating an example process for exploration of immersive video content with an angle of orientation difference between a main display and an immersive video client according to some embodiments.

FIG. 12 is a message sequencing diagram illustrating an example process for exploration of immersive video content with a display device such as a wearable AR headset according to some embodiments.

FIG. 13 is a message sequencing diagram illustrating an example process for exploration of immersive video content with a display device such as a wearable AR headset and an artificial mirror in an AR environment according to some embodiments.

FIG. 14A is a schematic perspective view illustrating an example immersive video content stream according to some embodiments.

FIG. 14B is a schematic perspective view illustrating an example director's decision for the main display view of an immersive video according to some embodiments.

FIG. 15A is a schematic perspective view illustrating an example device used to explore an immersive video environment according to some embodiments.

FIG. 15B is a schematic perspective view illustrating an example device used with a virtual mirror view of immersive video content according to some embodiments.

FIG. 16A is a schematic perspective view illustrating an example AR view displaying a virtual mirror of immersive video content located behind a user according to some embodiments.

FIG. 16B is a schematic perspective view illustrating an example AR view displaying immersive video content overlaid with an avatar according to some embodiments.

FIG. 17 is a flowchart illustrating an example process according to some embodiments.

FIG. 18 is a flowchart illustrating an example process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . .” For brevity and clarity of presentation, this implied leading clause is not repeated ad nauseum in the detailed description.

### EXAMPLE NETWORKS FOR IMPLEMENTATION OF THE EMBODIMENTS

A wireless transmit/receive unit (WTRU) may be used, e.g., as a mobile device or a 360-degree video content viewer/display in some embodiments described herein.

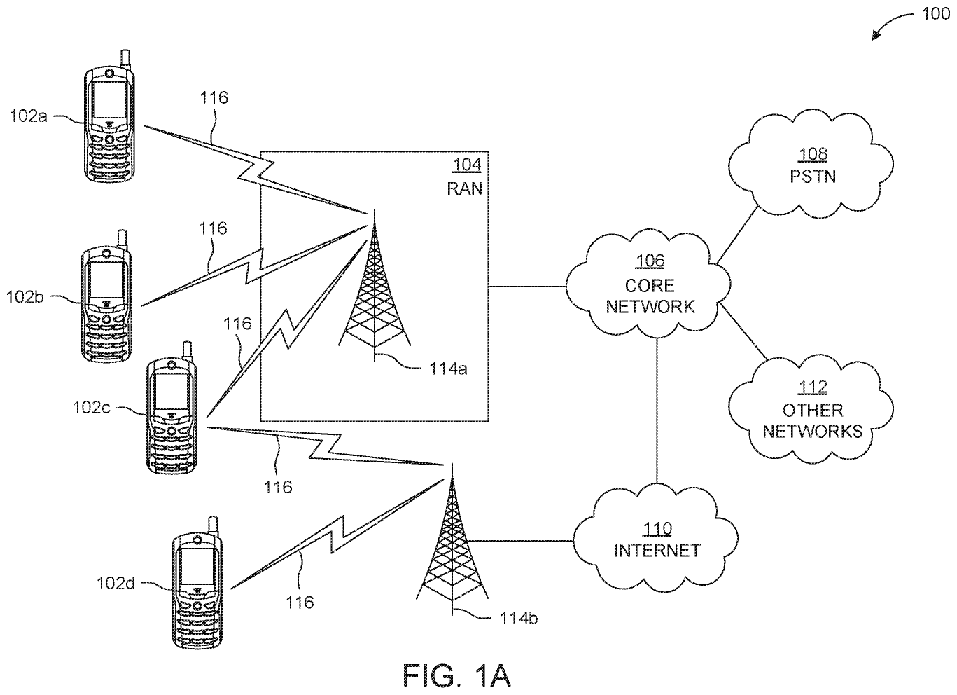

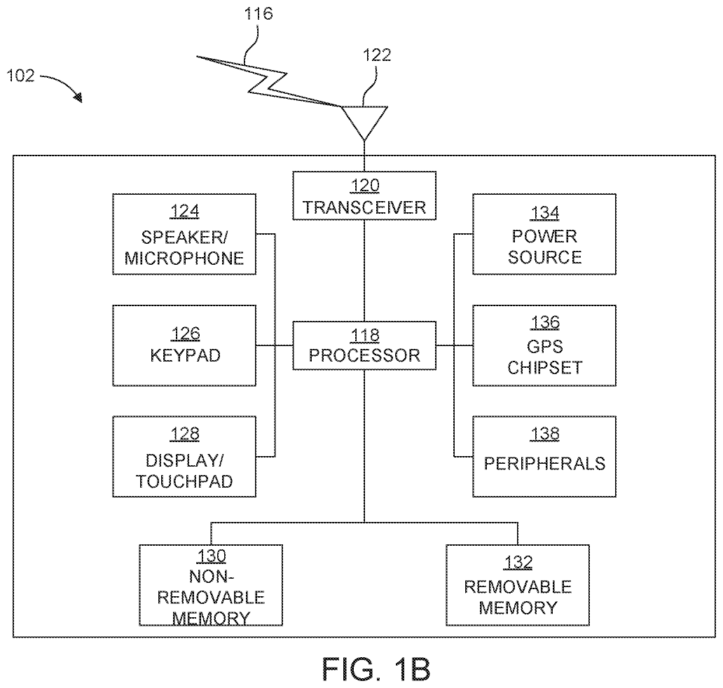

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

In view of FIGS. 1A-1B, and the corresponding description of FIGS. 1A-1B, one or more, or all, of the functions described herein with regard to one or more of: WTRU 102a-d, Base Station 114a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### DETAILED DESCRIPTION

Some methods and systems disclosed herein in accordance with some embodiments create and facilitate an immersive (e.g., 360-degree, 3D, 6D) video streaming experience. In some embodiments, an immersive video experience may be less than 360-degree or 3D-viewing but is configured and arranged such that a surrounding 3D view (or even 6D view) may be created for a user. Generally, for simplicity, in some embodiments, an immersive video streaming experience will be referred to as a 360-degree immersive video streaming experience. In some embodiments, a director or a content creator is able to control the presentation with flexible tools to drive the story telling. Additional contextual information included in the MPEG DASH protocol stream (used in some embodiments) may be used by, e.g., a director or content creator to create different versions without content modification. In some embodiments, spatial, or, e.g., spatial and temporal synchronization of the stream in multi-device environment enables the viewer to explore the 360-degree content freely and naturally. In some embodiments, a virtual mirror mode creates a “natural” experience natural with the viewer included within the presentation.

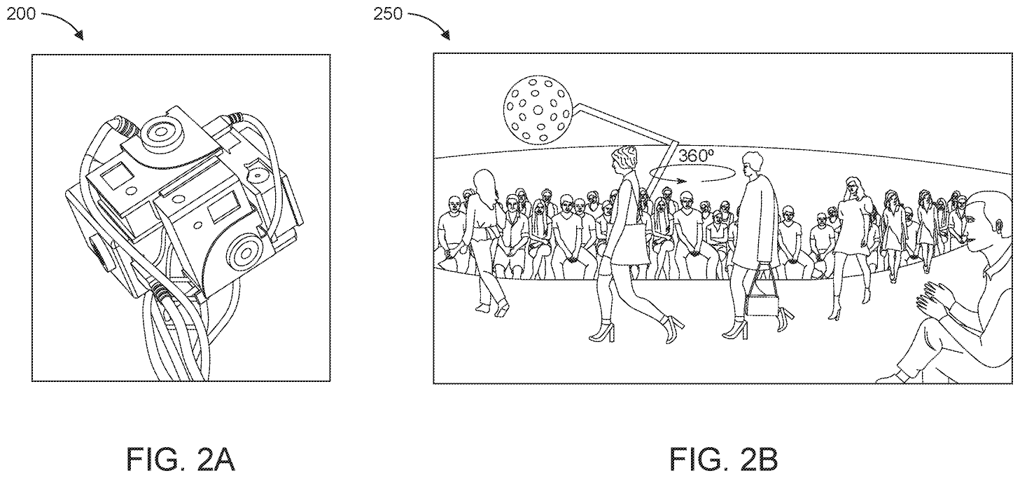

FIG. 2A is a schematic illustration showing an example video camera for recording an immersive video according to some embodiments. An immersive video may include, e.g., a 360-degree, 3D, or 6D video. For the example camera 200 shown in FIG. 2A, a lens is located on each of the six sides of a cube.

FIG. 2B is a schematic illustration showing an example viewport for viewing an video according to some embodiments. In the 2D viewport 250 of 3D content, the runway of a fashion show appears to originate at a right-center point of the figure and approach the viewer at the bottom center and continue towards the left-center point of the figure.

360-degree content generation is becoming easier to produce. Even consumer-grade recording devices are available. Many high-end devices have multi-camera setups. A 360-degree camera view may be similar to 6D content if transitions also are included.

One issue with 360-degree video streaming relates to controlling rendering and presentation of content. A content producer or content presentation director may lack full control on how a viewer experiences (or “consumes”) a presentation. A 360-degree view may contain a lot of different objects and events simultaneously. In some embodiments, users have the ability to explore, e.g., an image, or a portion of the presentation, or, e.g., to trace an object on the presentation. New user experiences may be created, in some embodiments, with a virtual mirror tool. Therefore, a meaningful story telling (as rated by a viewer) may be challenging if, e.g., viewers are not following the targets the content producer intended. 360-degree view enables several points of view for the same content. For example, a dialog may be followed from different directions. Hence, the director may control the story while the viewer is able to explore the content.

A multi-device environment enables individual exploration of the 360-degree content but the content handling may in some cases require special attention regarding temporal (or time) and/or spatial synchronization. If several devices are used simultaneously in the same space, those devices may use accurate synchronization (e.g., spatial and/or temporal) in accordance with some embodiments.

In a VR environment, users and viewers themselves may be represented as avatars, but if exploring 360-degree content with a mobile device or an AR headset, a different configuration may be used.

For some embodiments disclosed herein, rendering and representation of immersive (e.g., 360-degree) content may be controlled with directional metadata created by the content producer or director. The content may be shared with one or more receiving connected devices, e.g., mobile device(s), for multi-view rendering. The edited and controlled content (directors' cut) may be presented on, e.g., a (e.g., fixed) main 2D screen while the viewer may explore the 360-degree environment further with, e.g., mobile devices connected to the same video stream.

In some embodiments, the content is streamed to a main media player using MPEG DASH protocol in which the media presentation description (MPD) file may contain the adaptation sets for the audio-visual content. In addition, the MPD may carry metadata about the video camera orientation and position and a “director's cut” point of view to the content. The content creator, producer, or director may include the “director's cut” point of view and available frame size to the presentation. The streaming media may be rendered for a 2D display by cropping the received 360-degree stream to an area for a 2D point of view.

The user experience may be extended by sharing the 360-degree content with connected devices, such as mobile phones and tablets. Connected devices may receive the content from the streaming media player using local connectivity, or directly from the streaming service using the streaming protocol. For some embodiments, the user will view the director's cut on the main display and simultaneously swipe or rotate the screen of the connected mobile device, and hence, explore additional details of the presentation.

In some embodiments, connected devices may be used in virtual mirror mode so that the user may follow events, e.g., in a manner similar to using a real mirror. For some embodiments, the user herself may be captured with a back-facing camera and included in the presentation in a virtual mirror. A user's face may be cropped from the camera view and embedded on top of the mirrored video stream.

A multi-device environment may use (e.g., both) time and spatial orientation synchronization. The immersive (e.g., 360-degree) view of connected devices may be aligned in the same direction. If a mobile device's (or mobile phone's) back-facing, main camera is facing the main 2D screen, the content is the same on both displays. The view on the mobile device display may correspond to the main screen if the mobile is facing in that direction. The mobile device's back-facing camera capturing the main presentation on the main view may be used for both time and spatial orientation synchronization.

A multi-device environment also is available in Augmented Reality (AR) spaces. In addition to a wearable display device such as a wearable AR headset (such as, e.g., Google Glass or Microsoft HoloLens), the user may use additional mobile devices. For some embodiments, the functionality of the mobile device may be similar. The AR content may be presented on a mobile device screen, and the user may see the content through, e.g., the headset lenses.

For some embodiments, real-world objects may be used as (or replaced with) virtual displays or as virtual mirrors. If the user views a 360-degree presentation with an AR headset, an object in the view may be assigned as a display on which an application projects a separate view of the 360-degree presentation. In an AR environment, a real-live mirror or reflecting surface may be detected based on the visual characteristics. The AR application may use the reflecting surface as a virtual mirror surface on which the mirror image of the presentation is displayed. For example, if the real-live mirror or reflecting surface has a center compass heading of X degrees, the real-live mirror or reflecting surface may be replaced with presentation content that has a center compass heading of X+180 degrees if X is less than 180 degrees and X−180 degrees if X is 180 degrees or more. A center compass heading is a positive number less than 360 that is a compass heading for a midpoint of an object.

If a 360-degree content stream includes presentation control signaling, the content creator (or, e.g., director) may be able to define the experience. For example, a dialog between actors may be represented with different scene cuts according to a director's ideas. As another example, the view may represent a view from a vehicle (or car) window in which case the compass direction of the immersive presentation changes over time. The presentation director may select the point of view freely. However, for example, the content may be changed later by the director reconfiguring the presentation. This enables the content producer to adapt the content based on feedback and to tune the presentation for different audiences without changing the actual audio-visual stream.

From a user experience point of view, the multi-device environment, for some embodiments, may generally provide the most gain. Having additional views in the content may enable, for example, free exploration of the 360-degree and/or 6D content. In some embodiments, a director's cut may be presented in the main display (TV screen) while, e.g., connected devices enable exploration in different directions and transitions to different locations within the presentation. The presentation on the main display and the corresponding metadata regarding the point of view coordinates may be used for rendering the multi-device presentation with connected mobile devices.

In some embodiments, having virtual mirror mode functionality in connected mobile devices provides a way of viewing an environment that a viewer may see as more natural. For some embodiments, a front-facing camera is applied to capture and include the user on top of the 360-degree presentation in a connected device. Hence, the “mirror” effect also appears more natural in AR environment.

AR service may be more realistic if reflecting surfaces are detected and a mirror view of the 360-degree presentation is projected on it. In some embodiments, if content is viewed through an AR headset, real-world objects may be used as virtual mirrors. The example AR application may project a corresponding part of the presentation on a virtual mirror.

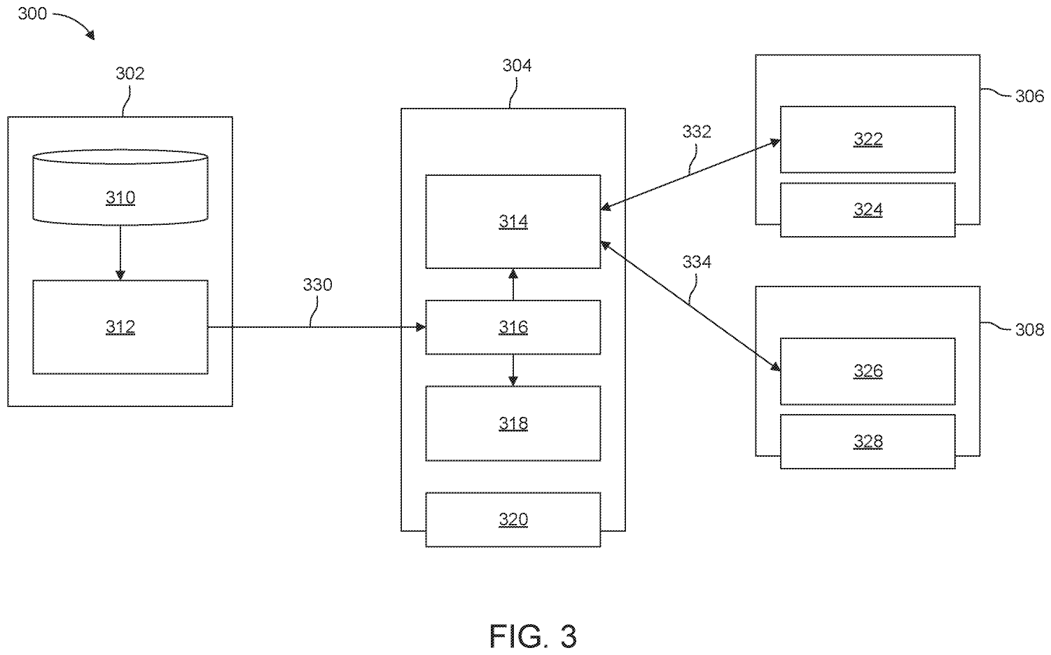

FIG. 3 is a system diagram illustrating an example set of interfaces for viewing immersive video on multiple mobile devices according to some embodiments. For some embodiments, a receiver display 304 may include a smart TV for receiving rich content and sharing the presentation with one or more connected devices 306, 308, such as mobile device(s) or, e.g., other display devices. A content producer (such as a TV broadcaster) 302 prepares (or, e.g., a content server (such as an ISP) communicates) (e.g.) audio-visual content with metadata 330 for transmission (which may be transmitted over, e.g., an MPEG DASH streaming protocol or using another broadcast system). The metadata may include the video capturing content and the content director's instructions for presentation. In some embodiments of a system 300, an ISP or TV broadcaster 302 may retrieve video on demand from a database server or may live stream video 310. The video content may be sent to an application, module, or server function 312 for bundling with contextual information. The bundled content and contextual information may be sent (e.g., via live streaming or a broadcast 330) to a receiver device 304.

The receiver module 316, part of a smart TV 304 for some embodiments, may unbundle the content stream 330 and present the main audio-visual content on the main 2D display 320 using a director's rendering instructions. For some embodiments, a receiver module may decode content for display. For some embodiments, a separate decoder module 318 may decode content for display. The smart TV (or receiving device or receiving device module 314) may share the 360-degree content with other connected mobile devices 306, 308. The receiving device 306, 308 may transcode (via a decoder module 322, 326, for example) the content for mobile device hardware, which may display the transcoded content on a local display 324, 328.

An application on (e.g.) a mobile device 306, 308 may establish a connection (e.g., via a Bluetooth or Wi-Fi connection) 332, 334 to a streaming application (e.g., on a smart TV 304) and receive the content stream 332, 334 that the smart TV 304 is sharing. If a connection 332, 334 is established, a mobile application on the mobile device 306, 308 may collect user information, local context, and sensor data to process the 360-degree content for presentation. The orientation of the device may be recorded so that, e.g., a media player may render the audio-visual content accordingly. In some embodiments, a mobile device user may explore the content by physically turning the mobile device 306, 308. For some embodiments, two or more mobile devices 306, 308 may receive a content stream 332, 334. For example, two mobile devices may receive a content stream with each mobile device receiving a separate viewpoint or viewport of the video content.

For some embodiments, throughout this disclosure one or more of the following terms may be used in place of another term: content producer, content creator, director, content director, presentation director, and, e.g., an automatic tool. For ease of description, any content source or presentation direction source (e.g., a content server) may provide content.

360-degree video streaming content may be created with live recording with special 360-degree camera and audio setup, or the content may be created off-line by stitching together several video streams and images. For example, 360-degree video content may be created using online tools, such as the content creation tools available on the website The Utimate Immersion: Create Awesome Panoramas, Virtual Tours, 360-Degree Videos, Kolor, www<dot>kolor.com (last visited Apr. 20, 2018). 360-degree video content created may be made available in a streaming service.

In some embodiments, in addition to the audio-visual content, the stream may contain continuous contextual sensor information flow about the instant location and vertical/horizontal orientation of the recording device. The sampling rate of the location/orientation data may be set to a high enough rate to capture the natural motion of the recording device.

A video stream may contain additional information about a director's desired view point to the 360-degree presentation. The stream may have metadata on rendering instructions. A 2D presentation control uses left and right border locations (which may be in compass angles) as well as upper and lower border angles relative to the horizon. This information (e.g., angle information) may be applied in the rendering of the presentation relatively to the receiving user.

A content creator may create rendering instructions, such as with a database file containing coordinates for a series of time instances. These rendering instructions may indicate a content creators view point for the viewer. Metadata may be used in a multi-device configuration for spatial synchronization of different presentations. The receiving device may stream 360-degree video content with related location and orientation data and with instructions on how to render the content on 2D display.

A 360-degree recording application may include metadata with contextual information about the video location and orientation. A 360-degree video may have details about the location and alignment of the view relative to a map. For example, polar coordinates from a motion API of the recording may be used. The motion API of the device may provide the data from GPS, acceleration, gyro, or compass sensors, for example.

A content producer, director, or an automatic tool may control a 2D presentation view of 360-degree content. Metadata may be added to a stream rendering instructions for a media player to render the presentation. The rendering instructions may be relative to the camera orientation. In some embodiments, the actual video content and corresponding metadata may be encapsulated in, e.g., Media Presentation Description (MPD) data model that may be available for streaming clients in a live streaming server.

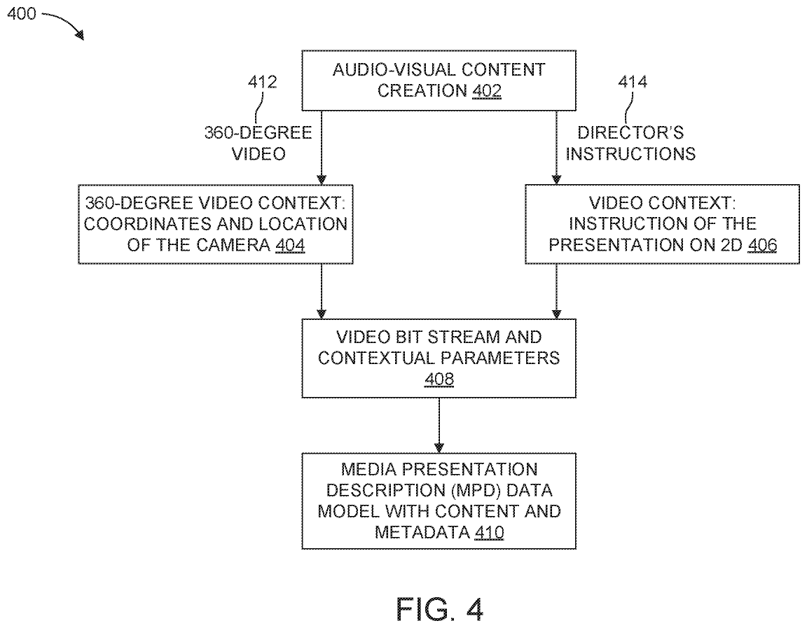

FIG. 4 is a flowchart illustrating an example process for creating video and metadata content for an immersive video stream according to some embodiments. An AV generation process 400 may include audio-visual content creation 402 that generates 360-degree video 412 and director's instructions 414. 360-degree video context may be recorded 404 as coordinates and location of the camera. For some embodiments, the coordinates may be recorded in polar coordinates format. A director's instructions may be generated 406 to indicate instructions for presenting video content in a 2D format, such as top, bottom, right, and left border locations. A video bit stream may be combined 408 with contextual parameters. The combined data may be translated 410 into, e.g., a Media Presentation Description (MPD) data model with video content and metadata.

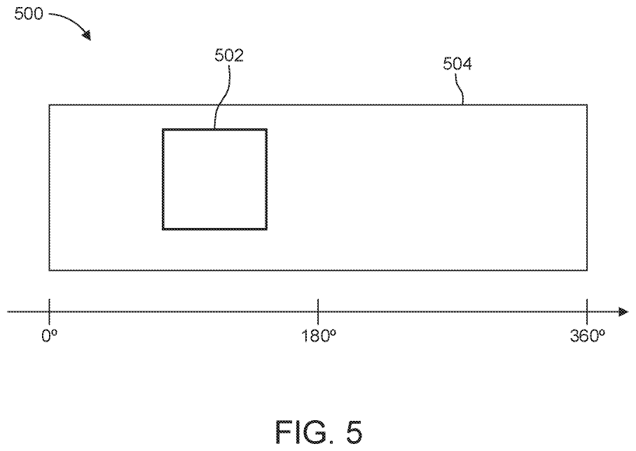

FIG. 5 is a schematic perspective view illustrating an example panel of an immersive video with an indication of a director's designated point of view according to some embodiments. A director may designate a point of view to the content that, at a given time instant, the main display may present as a subset of the presentation. Rendering instructions may indicate a director's desired view point (e.g., in polar coordinates) and the horizontal and vertical size of the frame (e.g., in degrees). For some embodiments, a viewport 502 is a subset of the immersive (e.g., 360-degree) video content 504, such as a director's point of view to the immersive video content. For the example configuration 500 shown in FIG. 5, a director's designated point of view has a heading centered about 105° with a left border at about 80° and a right border at about 130°. The vertical height may be 50° centered around a vertical heading of 90°.

In some embodiments, a created content stream may be stored in, e.g., a Media Presentation Description (MPD) manifestation file and corresponding encoded bit streams may be included in a Media Presentation Data Model. A receiving application may request a live video stream, and the media composition may be transmitted over HTTP in data blocks of short segments for each individual audio-visual stream. The MPD may contain both the content and related metadata on content location, orientation, sampling rates, and bit rates, for example.

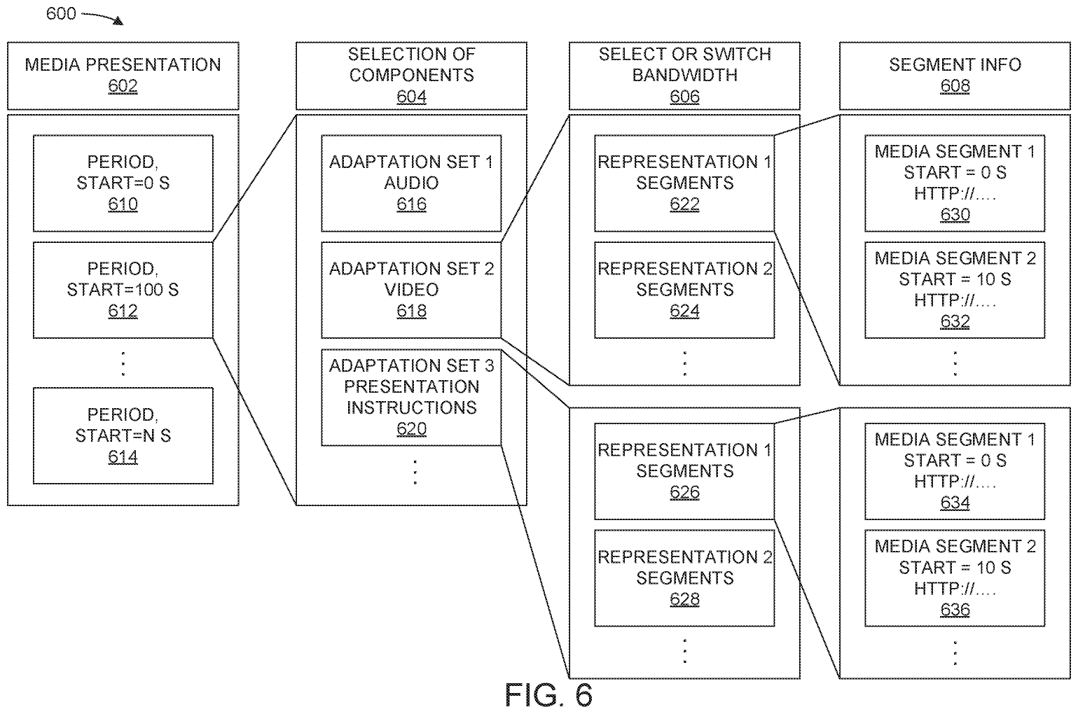

FIG. 6 is a structure block diagram showing an example segmentation of an immersive video according to some embodiments. FIG. 6 shows an example for some embodiments of a regenerated MPD 600 with rendering instructions indicated as adaptation set(s) 616, 618, 620. FIG. 6 presents an example of the structure of the MPD 600 if a director's instructions are included as time series data in separate adaptation sets 616, 618, 620. An MPD 600 may have more than one set of instructions. In some embodiments, the receiver may select the point of view to the content. For the example shown in FIG. 6, each segment within an adaptation set 616, 618, 620 may contain segment information 608 with one or more media segments 630, 632, 634, 636 that contain access details for HTTP streaming. An editor's instructions for content may be embedded in an MPD 600 as metadata, similar to a live stream from a recording application.

FIG. 6 shows an example hierarchy with 100 second (100 s) time periods 610, 612, 614 of a media presentation 602 in the left-most column of the figure. The left-center column of FIG. 6 shows a series of adaptation sets 616, 618, 620 that may be used in the selection of components 604. Media components (such as adaptation sets 616, 618, 620) may contain multiple streams, including time series metadata of a director's instructions for 2D presentation. Each time period of a media presentation may be associated with multiple adaptation sets 616, 618, 620. For example, set 1 (or group 1) may be an adaptation set 616 of audio settings. Adaptation set 2 (or group 2) may be an adaptation set 618 of video settings. Adaptation set 3 (or group 3) may be an adaptation set 620 of presentation instructions. The right-center column of FIG. 6 shows a series of representation segments 622, 624, 626, 628 that may be used for selecting or switching bandwidth 606. For example, a representation may contain bandwidth settings. The right-most column of FIG. 6 shows a series of media segments 630, 632, 634, 636. A media segment, for example, may contain segment information on how to access a set of 2D rendering instructions.

Table 1 shows an example of a MPD data model. Correlating FIG. 6 with Table 1, the field “MPD” indicates the start of an MPD data model structure. A media presentation time period may be indicated with the “Period” field and a period identifier (for example, ‘id=“1”’). Adaptation sets may be indicated with an “AdaptationSet” field and an adaptation set (or group) identifier (for example, ‘group=“1”’). Representations may be indicated with a “Representation” field and a representation identifier (for example, ‘id=“128 kps 240p”’). Media segments may be indicated with a “SegmentTemplate” field.

An MPD model may contain information (or fields) about media content, such as an XML schema instance for an XML namespace (for example, ‘xmlns:xsi=“www<dot>w3.org/2001/XMLSchema-instance”’), an XML namespace (for example, ‘xmlns=“urn:mpeg:dash:schema:mpd:2011”’), a schema location for an XML schema instance (for example, ‘xsi:schemaLocation=“urn:mpeg:dash:schema:mpd:2011 standards.iso.org/ittf/PubliclyAvailableStandards/MPEG-DASH_schema_files/DASH-MPD.xsd’), an MPD model type (for example, ‘type=“dynamic”’), an MPD model availability start time (for example, ‘availabilityStartTime=“2016-04-07T17:33:32Z”’), an MPD model publish time (for example, ‘publishTime=“2016-04-07T17:33:32Z”’), an MPD model time shift buffer depth (for example, ‘timeShiftBufferDepth=“PT3H”’), an MPD model minimum update period (for example, ‘minimumUpdatePeriod=“PT595H”’), an MPD model maximum segment duration (for example, ‘maxSegmentDuration=“PT5S”’), an MPD model minimum buffer time (for example, ‘minBufferTime=“PT1S”’), and an MPD model's profile settings (for example, ‘profiles=“urn:mpeg:dash:profile:isoff-live:2011,urn:com:dashif:dash264”’), among other fields.

Media presentation time period fields may include a period start field (start=“PTOS”), among other fields.

Adaptation set fields may include mime type (for example, ‘mimeType=“audio/mp4”’ and ‘mimeType=“video/mp4”’), minimum bandwidth (for example, ‘minBandwidth=“128000”’), maximum bandwidth (for example, ‘maxBandwidth=“128000”’), and segment alignment (for example, ‘segmentAlignment=“true”’), among other fields.

Representation fields may include representation bandwidth (for example, ‘bandwidth=“128000”’), codec selection (for example, ‘codecs=“mp4a.40.2”’), audio sampling rate (for example, ‘audioSamplingRate=“48000”’), frame rate (for example, ‘frameRate=“25”’), representation width (for example, ‘width=“320”’), representation height (for example, ‘height=“180”’), video sampling rate, and bit rate, among other fields.

Segment fields may include a segment duration (for example, ‘duration=“2”’), segment media location (for example, ‘media=“ . . . /dash/250k/bitcodin-$Number$.m4a” and media=“ . . . /dash/250k/bitcodin-$Number$.m4v”), segment initialization location (for example, ‘initialization=“ . . . /dash/250k/bitcodin-init.m4 a”’ and initialization=“ . . . /dash/250k/bitcodin-init.m4v”), segment start number (for example, ‘startNumber=“92352”’), and segment live edge number (for example, ‘liveEdgeNumber=“92352”’), among other fields.

A director's instructions may be included in similar manner. The director's desired view point with a 2D view border in horizontal and vertical direction may be embedded as separate time series data. Table 1 shows example data entries of camera location/orientation and director's instructions, which are indicated by the “StreamHighlight” and “StreamLimitHighlight” fields.

In addition, in some embodiments, an MPD model may contain metadata on content location metadata in polar coordinates (for example, ‘ref=“polar”’). Stream information also may indicate if the stream is at a fixed location, in which case the coordinate's information may be represented as fixed coordinates (such as polar coordinates). Alternatively, the stream may be a moving stream, and the coordinate information may indicate the initial coordinates (for example, ‘init-coord=“0,0,82,126”’), the final coordinates (for example, ‘final-coord=“0,0,82,150”’), and trajectory information (for example, ‘trajectory=“straight”’).

Other director instruction (“StreamHighlight” and “StreamLimitHighlight”) fields may include location of a director's instructions (for example, ‘src=“stream1.txt”’), the kind of director's instructions (for example, ‘kind=“highlight”’), and a director's instructions label (for example, ‘label=“marker”’), among other fields.

With rendering instructions as a separate adaptation set in an MPD file, the rendering may be changed separate from the content. A 2D presentation of the content may be edited without changing the actual audio-visual content. A receiving media player may use stream meta-information to render the 2D presentation on a screen.

TABLE 1
MPD Data Model Structure

<MPD xmlns:xsi=“www<dot>w3.org/2001/XMLSchema-instance″

xmlns=″urn:mpeg:dash:schema:mpd:2011″
xsi:schemaLocation=″urn:mpeg:dash:schema:mpd:2011
standards.iso.org/ittf/PubliclyAvailableStandards/MPEG-
DASH_schema_files/DASH-MPD.xsd″ type=″dynamic″
availabilitystartTime=″2016-04-07T17:33:32Z″
publishTime=″2016-04- 07T17:33:32Z″
timeShiftBufferDepth=″PT3H″ minimumUpdatePeriod=″PT595H″
maxSegmentDuration=″PT5S″ minBufferTime=″PT1S″
profiles=″urn:mpeg:dash:profile:isoff-
live:2011,urn:com:dashif:dash264″>
<Period id=″1″ start=″PT0S″>

<AdaptationSet group=″1″ mimeType=″audio/mp4″

minBandwidth=″128000″ maxBandwidth=″128000″
segmentAlignment=″true″>
<Representation id=″128kbps″ bandwidth=″128000″

codecs=″mp4a.40.2″ audioSamplingRate=″48000″>
<SegmentTemplate duration=″2″

media=″../dash/250k/bitcodin-$Number$.m4a″
initialization=″../dash/250k/bitcodin-init.m4a″
startNumber=″92352″
liveEdgeNumber=″92352″/>

</Representation>

</AdaptationSet>
<AdaptationSet group=″2″ mimeType=″video/mp4″

segmentAlignment=″true″>
<Representation id=″250kbps 240p″ frameRate=″25″

bandwidth=″250000″ codecs=″avc1.42c00d″
width=″320″
height=″180″>
<SegmentTemplate duration=″2″

media=″../dash/250k/bitcodin-$Number$.m4v″
initialization=″ ../dash/250k/bitcodin-init.m4v″
startNumber=″92352″
liveEdgeNumber=″92352″/>

</Representation>

</AdaptationSet>
<StreamHighlight src=″stream1.txt″ kind=″highlight″

label=″marker″ init-coord=″0,0,82,126″
final-coord=″0,0,82,150″ trajectory=“straight”
ref=″polar″/>

<StreamHighlight src=″stream2.txt″ kind=″highlight″

label=″marker″ fixed-coord=″0,0,82,126″ ref=″polar″/>

<StreamLimitHighlight src=″stream_presentation1.txt″

kind=″highlight″ label=″marker″ init-coord=″100,0,0,0″
trajectory=“straight” ref=″polar″/>

<StreamLimitHighlight src=″stream_presentation2.txt″

kind=″highlight″ label=″marker″ fixed-coord=″100,0,0,0″
ref=″polar″/>

</Period>

</MPD>

In accordance with some embodiments, if a user is exploring a 360-degree presentation, presentation of content on each separate display may be aligned. A receiving application on a mobile device may be, e.g., spatially and (e.g.) temporally synchronized with a presentation on a main display in the multi-device environment. If a mobile device with back-facing camera is pointing towards the main display, the content displayed in the same direction on each display may be time synchronized.

In some embodiments, temporal synchronization may be performed by determining a target content transmission time and rendering and matching delays between different devices. However, in some embodiments, a main receiver may not record whether there are connected devices or lead times for those connected devices. For some embodiments, a back-facing camera of a connected device may be used to capture content. The captured content may be correlated with the received content to compensate for transport and rendering delays.

In some embodiments, spatial synchronization may be performed in a manner similar to temporal synchronization. If the back-facing camera is pointed towards the main display, the rotation context of the connected device may be aligned with the location of a main display. A connected device may match the streaming content with the captured video. Comparing the local orientation context with the 2D content rendering instructions (the details of the presentation direction on the 2D view), the connected device may determine its own relative orientation to the main display.

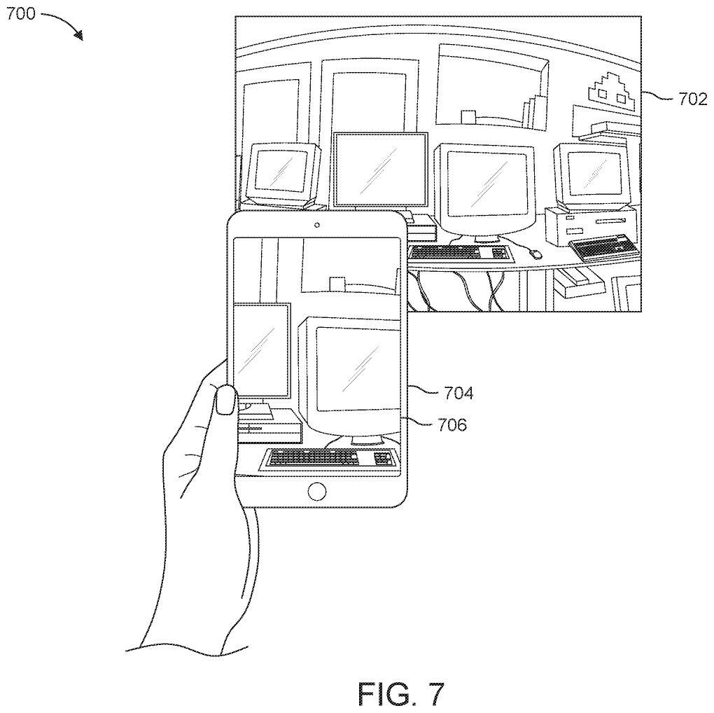

FIG. 7 is a schematic perspective view illustrating an example synchronization of content between two displays according to some embodiments. In some embodiments, a spatial synchronization may synchronize the orientation in an environment 700 between content displayed on a main (e.g., fixed or, e.g., stationary) display 702 (which is shown in the background of FIG. 7) and content displayed on the display 706 of a mobile device 704. For the example of FIG. 7, the presentation of the 360-degree content on the mobile device 704 is aligned with the director's cut presentation on the main display 702. With performance of temporal and spatial alignment, a connected mobile device 704 pointed towards the main display 702 may display a video stream identical to a portion of a video stream displayed on the main display 702.

FIG. 8 is a schematic perspective view illustrating an example synchronization of a TV display and two mobile devices according to some embodiments. FIG. 8 shows an example configuration 800 of a director's cut for rendering on a main display 804, which may be a fixed view on a TV screen. FIG. 8 shows two mobile devices 802, 806 with synchronized views. The mobile device 802 on the left side of FIG. 8 is rotated counter-clockwise (relative to the main display 804) as seen from above. The display for the left mobile device 802 has a synchronized left-looking view 808 in comparison with the view of the main display 804 that shows a straight-ahead view 810. The right mobile device 806 of FIG. 8 is rotated clockwise (relative to the main display 804) as seen from above. The display for the right mobile device 806 has a synchronized right-looking view 812 in comparison with the main display's straight-ahead view 810.

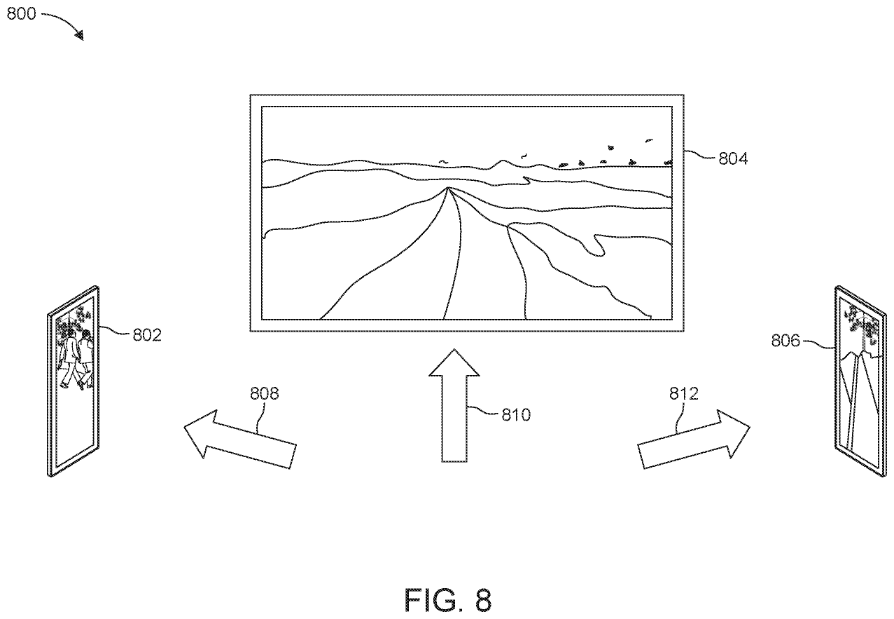

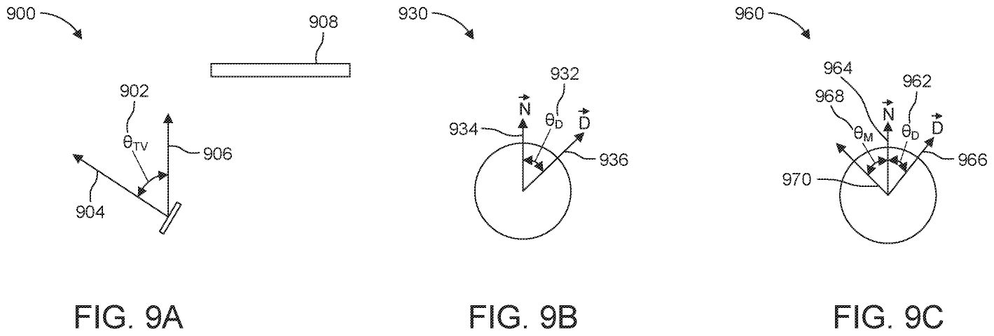

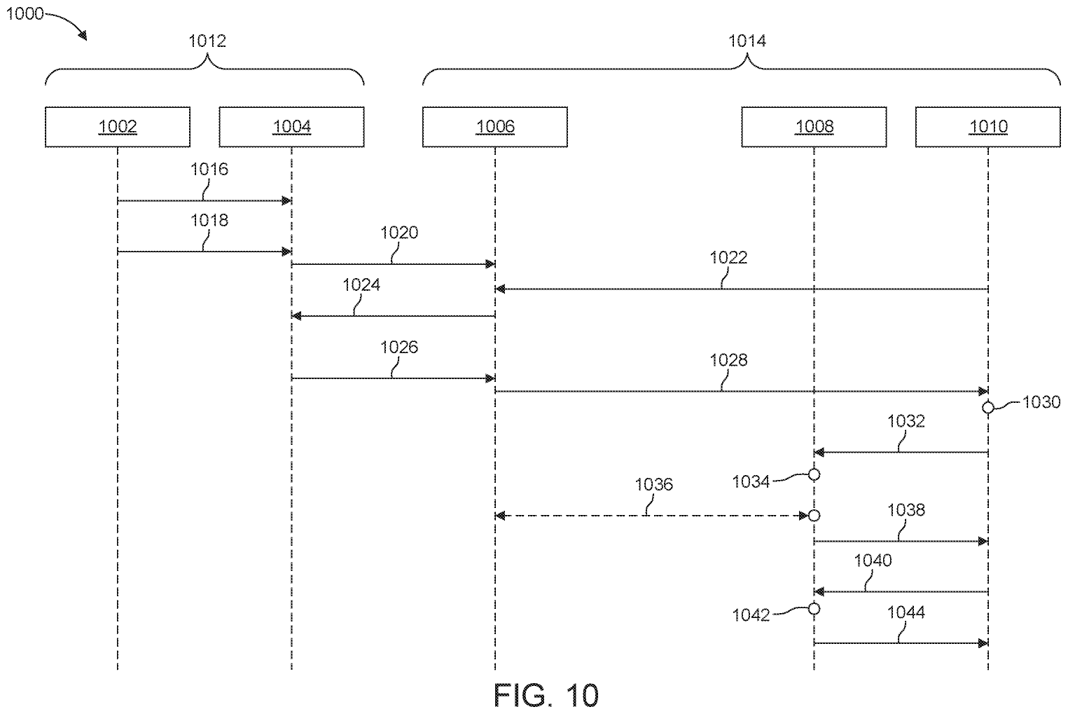

FIGS. 9A-9C are schematic plan views illustrating an example for determining content and mobile device viewport orientations relative to scene and other geometry according to some embodiments. For example, a method may determine an orientation of a mobile device relative to a director's viewport of an immersive video.

For FIG. 9A, illustrating a scene geometry environment 900, a mobile device may track an orientation relative to the orientation of the television (TV) 908. The angle θ_{TV} 902 is the angle between a TV vector 906 normal (perpendicular) to the television display 908 and a mobile normal vector 904 normal to a mobile device's display. For some embodiments, a mobile tracks relative orientation between the mobile and a TV display.

For FIG. 9B, illustrating a content viewport environment 930, a director's viewport may be communicated (signaled) as metadata. θ_{D} 932 is the angle for the director's viewport (\vec{D}) 936 relative to content north (\vec{N}) 934. From the mobile device point of view, the TV normal vector 906 is the same as the director's viewport vector 936, as the TV normal vector 906 is basically the viewpoint to the content shown on the television display 908. The director may design the content by selecting the angle θ_{D} 932. That is, the content selected from the 360-degree content relative to the content north vector 934.

For FIG. 9C, illustrating a mobile viewport environment 960, the direction of a mobile device's viewport 970 may be calculated from the TV normal vector 906, the mobile normal vector 904, and the director's viewport angle θ_{D} 962. θ_{M} 968 is the angle for the viewport of the mobile display relative to content north (\vec{N}) 964. From the mobile device's point of view, the TV normal vector 906 of FIG. 9A is equal to the director's viewpoint vector (\vec{D}) 936, 966 of FIGS. 9B and 9C. Eq. 1 states that the mobile device angle, θ_{M} 968, is equal to the angle between the mobile normal vector 970 and the TV normal vector 966 minus the angle between the content north vector (\vec{N}) 964 and the director's viewport vector (\vec{D}) 966 (the TV normal vector from the perspective of the mobile device):

θ_{M}=θ_{TV}−θ_{D} Eq. 1

If the director's viewport 966 is on the left side of the compass north vector 964 causing θ_{D} 962 to be a negative value, Eq. 1 works for this case as well. For example, if the director's viewport vector (\vec{D}) 966 is facing the content north vector (\vec{N}) 964 and θ_{D} is zero, content on the mobile device depends only on the mobile device rotation for some embodiments. If the mobile device is facing the TV and θ_{TV} is zero, the content on the mobile device depends only on the director's viewport angle θ_{D} 962 for some embodiments.

For some embodiments, tracking a relative orientation between a main TV display and a mobile device display may include: determining (or measuring) a first compass (or gyro) direction (e.g., a heading) of the mobile device display for a condition where the main TV display is parallel to the mobile device display at a time t1; determining a second compass direction (e.g., a heading) of the mobile device display at a time t2; determining a heading difference between the first compass direction (e.g., a heading) and the second compass direction (e.g., a heading); and storing the heading difference to track the relative orientation between the main TV display and the mobile device display.

For some embodiments, the main TV display and the mobile device may each have a gyro. Determining a relative orientation between the main TV display and the mobile device may comprise reading the gyro heading on the main TV display and on the mobile device. The relative orientation between the main TV display and the mobile device may be the difference between the two gyro readings.

For some embodiments, determining a modified or mobile device's viewport (e.g., mobile device viewport 970) may include: determining a first angle (e.g., θ_{TV} 902) from the orientation of the mobile device's display (e.g., the mobile normal vector 904) relative to a first display; determining a second angle (e.g., θ_{D} 932) from a center of a viewport (e.g., the content north vector (\vec{N}) 934) of an immersive video displayed on another display (e.g., a mobile device); and orienting, for the second angle (e.g., θ_{D} 932), the immersive video synchronized in, e.g., time and orientation to generate the modified or mobile device's viewport (e.g., mobile device viewport 970). For some embodiments, the modified viewport may be determined based on the first and second angles, such as the relationship shown in Eq. 1, for example, wherein θ_{TV} is the first angle, θ_{D} is the second angle, and θ_{M} is the angle for the modified viewport.

FIG. 10 is a message sequencing diagram illustrating an example process for exploration of immersive video content with a virtual mirror according to some embodiments. For the example process 1000 of FIG. 10, the multi-device environment 1014 may include a (e.g., fixed) main 2D display 1006 (e.g., a smart TV) that receives a stream from a server and a mobile device (such as a tablet) connected to a service offering the stream. A mobile user device, such as mobile phone or tablet, may be connected directly to a main display (e.g., using Bluetooth or Wi-Fi), or a mobile device may be connected independently to the service (e.g., over a cellular network). For some embodiments, the mobile device may connect with a main display using a QR code, a URL, or a hyperlink (one or more of which may be available on the presentation running on a main display). Alternatively, the mobile device may use content recognition to identify the presentation on the main display or to search for a stream on the Internet.

For the example of FIG. 10, a broadcast or streaming service 1012 may have access to content, e.g., originating from a live event or from a video on demand database. In some embodiments, a content director 1002 may combine the, e.g., audio-visual content 1016 with contextual information for the camera setup and the rendering instructions to create the main presentation. In some embodiments, a director's instruction metadata 1018 may be combined with broadcasted or streamed content 1016. Both audio/visual source content 1016 and a director's instruction metadata 1018 may be sent from a content server 1002 to a video server 1004. The MPD manifestation content description 1020 may be communicated from a video server 1004 to a main display receiver 1006 (such as a smart TV). A user 1010 via a mobile device 1008 (such as a tablet) may send a message 1022 to the main display 1006 to start the presentation on the main display. The main display 1006 receives the start message 1022 and may send 1024 a content request to the video server 1004. For some embodiments, the main display 1006 may select a stream from a broadcast. The video server 1004 may respond 1026 to the main display 1006 with a content stream with metadata. According to the example, the main display 1006 displays a presentation. The user 1010 views 1028 the main display's presentation. In some embodiments, if the connected device 1008 establishes 1034 a connection to the service (in FIG. 10), the device is connected to the MPD. The service connection may be through, e.g., the smart TV or may be a direct connection (e.g., over a cellular network). Using the captured view of the main display's presentation, a user 1010 selects 1030 a content stream via the connected device 1008. The user 1010 may make an indication via a user interface on a mobile device 1008 to connect 1032 to content. The mobile device 1008 may establish 1034 a connection to the broadcast or streaming service.

The 2D content may be edited based on the metadata and rendered immediately on the local display. The user 1010 may desire more information and an additional view point to the presentation. The user 1010 may connect the connected device 1008 (e.g., a mobile device, a smart phone, or a tablet) to the stream. This connection to the broadcast or streaming service 1012 may be made independently (e.g., via a cellular network) or directly to the main display receiver 1006 (e.g., using Bluetooth or a Wi-Fi connection).

The receiver may use a local connection for sharing 360-degree content together with context information about the capturing camera location and orientation. Metadata containing rendering instructions for the main display 1006 may be used by connected device(s) 1008 to perform 1036 spatial synchronization. The connected device 1008 may use a camera to trace 1042 the main display and to synchronize the content stream both temporally and spatially. The user, e.g., points the camera towards the main display to enable the synchronization.

A connected device 1008, such as a mobile phone or a tablet, may receive a content stream and metadata. Locally, the connected device 1008 may capture the connected device's orientation and user interactions (which may be done using, e.g., an acceleration sensor, a compass, a touch screen, or a keyboard). A user 1010 also may zoom in to the content (e.g., using pinch and swipe gestures on the touch screen or dedicated buttons on a keyboard). For some embodiments, tracking a relative orientation between a first display (such as a fixed display) and a second display (such as a mobile device) may include determining a first direction of the second display relative to the first display at a first time; determining a second direction of the second display relative to the first display at a second time; determining a heading difference between the first direction and the second direction; and storing the heading difference as the relative orientation between the first display and the second display. For some embodiments, a gyro sensor may be used to determine relative orientation, such as the first and second directions of a mobile device. For some embodiments, if the main display 1006 is visible in the camera view of the connected device 1008, the relative angle (between the main display 1006 and the connected device 1008) may be determined visually. For some embodiments, multiple camera images may be compared to determine relative orientation changes of a mobile device relative to a fixed display or other stationary object in the camera images.

Combining the device orientation with the stream metadata on camera orientation, the media player on the connected device 1008 may render the 2D representation of the 360-degree content. The device crops the relevant part of the 360-degree content and renders the cropped content on the display. The connected device may display the cropped content, which is viewed 1038 by the user 1010. Hence, in some embodiments, the user 1010 is able to explore the presentation by turning (or rotating) the mobile device.

For some embodiments, a 360-degree presentation may be explored by switching to virtual mirror mode and using the connected device as a mirror. The user may make a selection in the connected device's 1008 user interface to select 1040 virtual mirror mode.

In some embodiments with a virtual mirror mode, the connected device's 1008 front-facing camera may be aimed to trace the user herself and capture a live image. An application on the connected device may crop 1042 the user image from a camera stream (or live image stream), create 1044 a virtual mirror view of the 360-degree content, and overlay the user image on top of the 360-degree content presentation.

For some embodiments, determining a viewport of the immersive video may include determining a virtual mirror viewport of the immersive video, such as, for example, a user 1010 indicating 1040 a selected virtual mirror to a connected device 1008 and a connected device 1008 displaying 1044 a virtual mirror view of immersive video content. For some embodiments, an image may be recorded by a camera (such as a front-facing camera) of a mobile device to generate a recorded image. A boundary of a user in the image may be determined to generate a shape of the user within the image. The image may be cropped to remove the background by tracing the shape of the user within the image to generate a cropped image. The cropped image may be displayed as an overlay over a viewport of an immersive video.

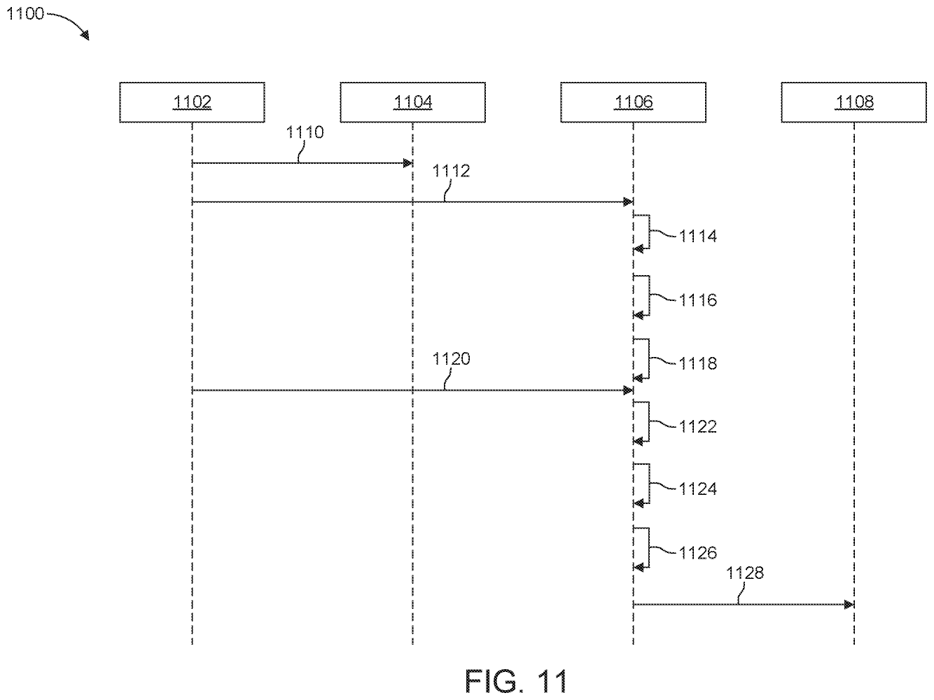

FIG. 11 is a message sequencing diagram illustrating an example process for exploration of immersive video content with an angle of orientation difference between a main display and an immersive video client according to some embodiments. For the example process 1100 of FIG. 11, an immersive video client (or connected device) 1106 may connect directly with a video content server 1102 (or broadcast/streaming service). The primary video may be transmitted 1110 from a server 1102 to the main display 1104. Immersive video may be transmitted 1112 from the server 1102 to the immersive video client 1106. According to the example, content displayed on the immersive video client 1106 may be synchronized (e.g., spatially and/or temporally) 1114 with the content displayed on the main display 1104. The immersive video client (or connected device) 1106 may be rotated to generate an angle of orientation between the main display (which may be a television) 1104 and the immersive video client 1106. The immersive video client's orientation relative to the main display 1104 may be tracked 1116, and an angle of orientation relative to the main display may be computed 1106. Metadata with a director's viewport is sent 1120 from a server 1102 to the immersive video client 1106. For some embodiments, the immersive video client 1106 may subtract 1122 director's viewport angle from main display angle. The immersive video client 1106 may determine 1124 the viewport using the angle to the main display and the angle to the director's viewport using, for example, Eq. 1 above. The immersive video client 1106 may determine 1124 a viewport based on the angles. The immersive video client 1106 may render 1126 the viewport of the immersive video. The rendered video is displayed 1128 on the immersive video client's display.

For some embodiments, the user is able to switch between exploration and virtual mirror modes. For some embodiments, the user may switch between exploration and virtual mirror mode with a virtual button rendered on a touch screen. For some embodiments, a mobile device (or connected device) may crop, render, and display a view of 360-degree content for the direction at which the device is pointing.

For some embodiments, a mobile device may be used in a virtual mirror mode. In an example virtual mirror mode in accordance with some embodiments, the mobile device may render and display, in an immersive (e.g., 360-degree) presentation, the view behind (e.g., directly behind) the device and the user (in, e.g., the opposite direction at which the device is pointing). For some embodiments, virtual mirror mode may offer a way to explore a view of 360-degree content behind the user. Virtual mirror mode may enable a user to appear on the mirror. A front-facing camera may capture the environment behind the device and the user. The media player also may capture a video image of the user. In some embodiments, if the media player renders a 360-degree view of content behind the user, the media player may crop (or trace) the users video image from the camera view and embed the video image on top of the presentation.

For some embodiments, the 360-degree content created in, e.g., FIG. 4 may be augmented reality (AR) content. The stream may have audio visual components that are rendered in predetermined locations relative to the user. For some embodiments, there is no 2D presentation nor rendering instructions for a director's cut. The AR objects may be displayed and viewed by a user (e.g., with a wearable AR-type device). The user may be able to experience different viewpoint angles in a 360-degree environment by turning her head.

Multiple devices may be used with an AR experience. A user may have a connected device (such as a mobile phone or a tablet) connected to the same content as the wearable device. The connected (or mobile) device may render the content based on the location and orientation (similar to the wearable device). A similar temporal and spatial synchronization process may be used. The mobile device may render the same content in same direction in the same time frame as the content in the wearable device. A camera module in the wearable device may be used for synchronization: The wearable device may record the content displayed on the mobile device and perform temporal and spatial synchronization.

In some embodiments, a mobile device in a multi-device configuration may be used as a virtual mirror in an AR environment. The mobile device may be synchronized with the main content in the wearable device and used as a virtual mirror. The mobile device may render content that is behind the user. Within virtual mirror mode, the user may be able to explore 360-degree content with the wearable headset without director instructions. The mirror may help the user to explore and experience the environment. The user's own mirror image may be projected on the display, which may be similar to a VR environment.

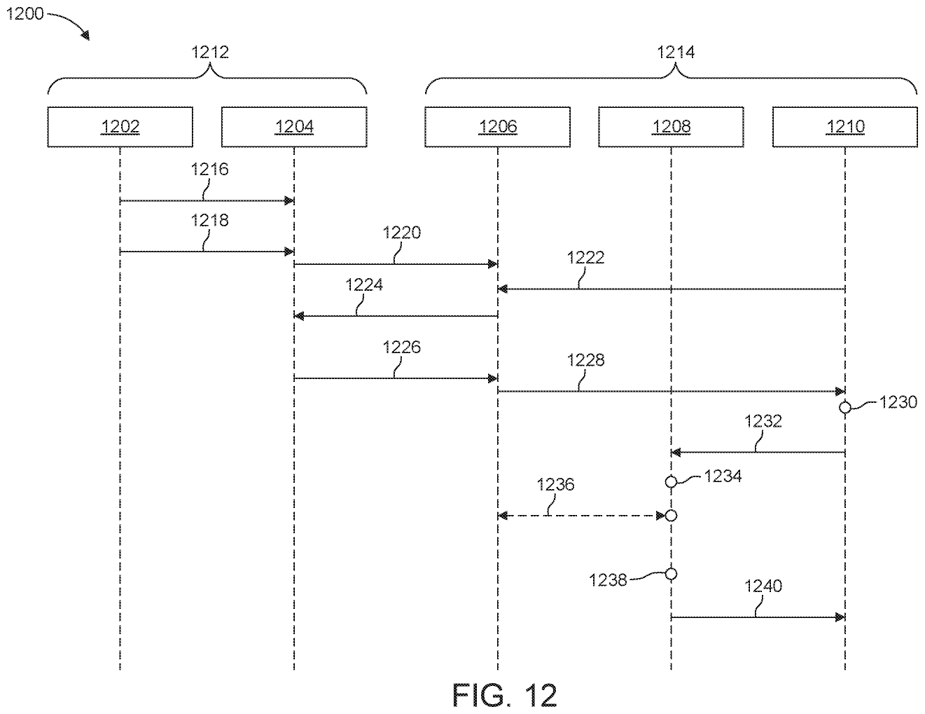

FIG. 12 is a message sequencing diagram illustrating an example process for exploration of immersive video content with a wearable AR headset according to some embodiments. A wearable AR headset may be in a virtual mirror mode for some embodiments. For the example process 1200 of FIG. 12, a broadcast or streaming service 1212 may have access to content originating from a live event or from a video on demand database. In both cases, a content director 1202 may combine the audio-visual content with contextual information for the camera setup and the rendering instructions to create the main presentation. A director's instruction metadata may be combined with broadcasted or streamed content. Both audio/visual source content 1216 and a director's instruction metadata 1218 may be sent from a content server 1202 to a video server 1204. For some embodiments, multi-device 360-degree content exploration in an augmented reality (AR) experience 1214 may be a user 1210 exploring an AR environment with a wearable AR headset 1206 and a mobile device 1208. The MPD manifestation content description may be communicated 1220 from a video server 1204 to a wearable AR headset 1206. A user 1210 may make 1222 an indication to start the presentation on the wearable headset via a user interface for the wearable headset. The wearable AR headset 1206 may receive the start message and may send 1224 a content request to the video server 1204. The video server 1204 may respond 1226 with a content stream and metadata. The user 1210 may view 1228 the 360-degree presentation via the wearable AR headset 1206. Using the user interface for the wearable AR headset 1206, the user 1210 may select 1230 a mobile device. The user may make an indication via the user interface on the mobile device to connect 1232 to content. The mobile device 1208 may establish 1234 a connection to the broadcast or streaming service 1212. The mobile device 1208 may perform 1236 temporal and spatial synchronization with a wearable AR headset 1206. The mobile device 1208 may, e.g., trace 1238 the users image within a camera image of the user. The traced image may be overlaid on the mobile device's presentation of content. According to the example, the user 1210 sees 1240 the virtual mirror view of the 360-degree content displayed on the mobile device.

For some embodiments, a real-world object visible through a wearable AR device may be assigned as a mirror. For example, an object the user sees through the wearable AR device may be selected in an AR environment as an artificial mirror. For example, using hand gestures and AR menus, the user may select an area in an AR environment and assign a mirror surface on the selected area. The application may project a mirror image of the AR scenery behind the user on the selected area in the AR environment. The user may see an artificial mirror image of an AR view projected on the selected area.

In some embodiments, determining a viewport of an immersive video may include: capturing an image of the immersive video displayed on the first display to generate a captured image; determining a first time instant that the captured image is captured; determining a second time instant that a first portion of the immersive video corresponding to the captured image is displayed; determining a time delay as the difference between the first time instant and the second time instant; time-adjusting the second viewport based on the time delay to generate a time-adjusted viewport; and displaying the time-adjusted viewport on the second display. An example of the temporal synchronization 1236 shown in FIG. 12 may be performed as described above for some embodiments.

An example of a spatial synchronization 1236 shown in FIG. 12 may be performed as described below for some embodiments. Tracking the orientation of a first display relative to a second display may include: determining a first compass heading of the first display when the second display is parallel to the first display at a first time (e.g., time t1); determining a second compass heading of the first display at a second time (e.g., time t2); determining a heading difference between the first compass heading and the second compass heading; and storing the heading difference as the orientation of the first display relative to the second display.

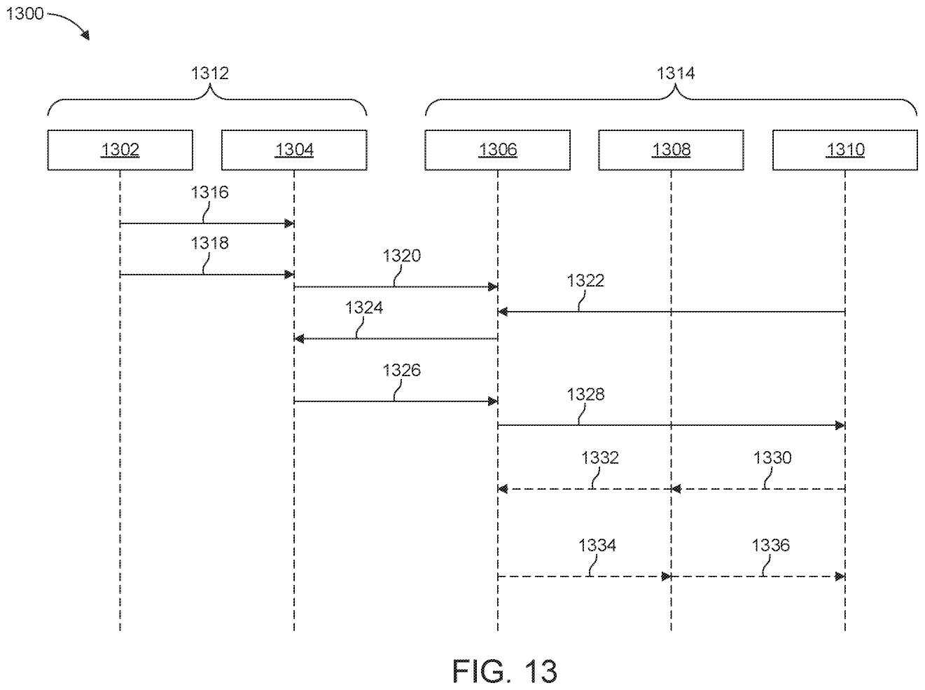

FIG. 13 is a message sequencing diagram illustrating an example process for exploration of immersive video content with a wearable AR headset and an artificial mirror in an AR environment according to some embodiments. For some embodiments, 360-degree content exploration in an augmented reality (AR) experience with an artificial mirror 1314 may be a user 1310 exploring an AR environment with a wearable AR headset 1306 and an artificial object in the AR view acting as a mirror (e.g., an artificial mirror) 1308. For the example of FIG. 13, a broadcast or streaming service 1312 may have access to content originating from a live event or from a video on demand database. In both cases, a content director 1302 may combine the audio-visual content with contextual information for the camera setup and the rendering instructions to create the main presentation. A director's instruction metadata may be combined with broadcasted or streamed content. Both audio/visual source content 1316 and a director's instruction metadata 1318 may be sent from a content server 1302 to a video server 1304. The MPD manifestation content description may be communicated 1320 from a video server 1304 to a wearable AR headset 1306. A user 1310 may make 1322 an indication to start the presentation on the wearable headset 1306 via a user interface for the wearable headset 1306. The wearable AR headset 1306 may receive the start message and may send 1324 a content request to the video server 1304. The video server 1304 may respond 1326 with a content stream and metadata. The user 1310 may view 1328 the 360-degree presentation via the wearable AR headset 1306. The user 1310 may select 1330 an object or area as a mirror in the AR view. The wearable AR device 1306 may record 1332 the user selection and may determine the location and geometry of the selected surface. The wearable AR device 1306 may project 1334 the virtual mirror image on the artificial mirror object (or selected surface) within the AR view. According to the example, the user 1310 uses 1336 the artificial mirror view to see 360-degree content located behind the user. For some embodiments, the wearable AR device 1306 may project the virtual mirror image on the object while the user moves the object around. The relative motion of the object compared to the wearable AR device 1306 may be used in determining the location geometry of the selected surface for the artificial mirror 1308.

360-degree content may include audio-visual streams from different locations. The streams may be spatially different but may be linked to each other. For example, the streams may cover the same event. In some embodiments, connected devices may have an option to explore spatially different points of view to an event. For example, coverage of the Tour de France includes several different feeds of the race. One stream may cover the race leaders while another stream follows, e.g., a pack of bikers behind the leaders. A director's cut on a main display may show the pack of bikers behind the leaders, and a user may use a connected device to show the race leaders. As another example, coverage of a tennis match, a football game, soccer, hockey, baseball, or other sporting event may include several feeds, and a director's cut focusing on one perspective (e.g., a server in tennis, a quarterback in football) might be supplemented at a connected device by another simultaneous time and spatially synchronized perspective (e.g., a returner in tennis, a receiver in football, or other angles and views).

For some embodiments, determining a viewport of an immersive video may include selecting a location of a virtual mirror corresponding to a portion of the immersive video displayed. Such a virtual mirror location may be selected based on a user indicating a selection of an object as a mirror in an AR view of the immersive video. With some embodiments, displaying a viewport of the immersive video may include rendering a portion of the immersive video corresponding to the location of the virtual mirror and/or replacing the virtual mirror object with a portion of a viewport of the immersive video.

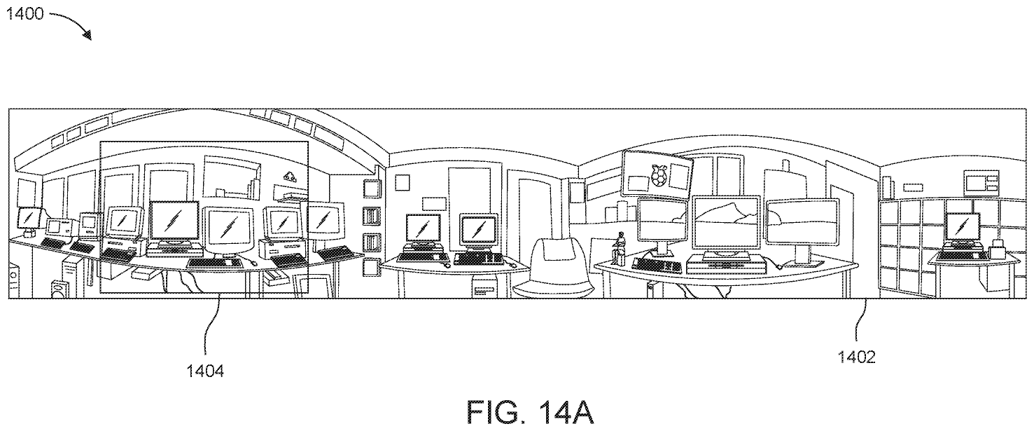

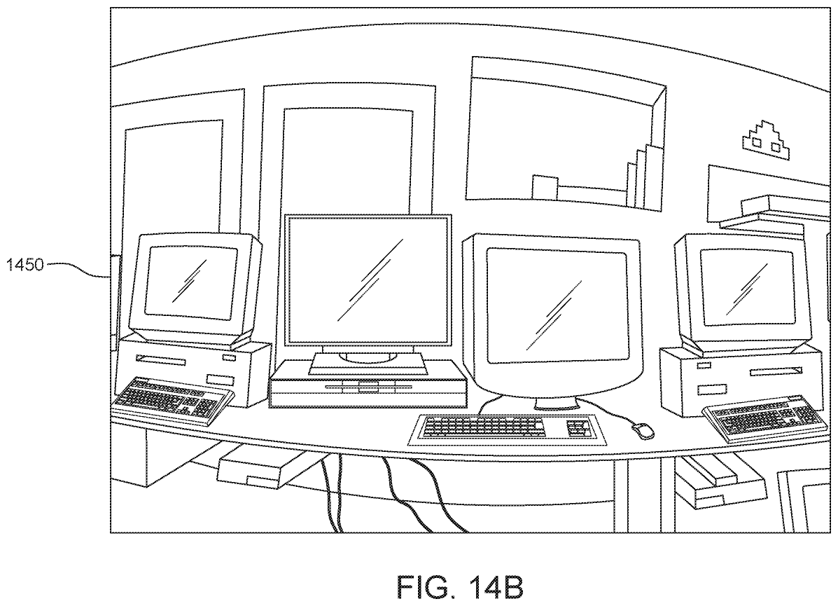

FIG. 14A is a schematic perspective view illustrating an example immersive video content stream according to some embodiments. In some embodiments, 360-degree content distribution may include creation of content, insertion of metadata, and streaming of content to a viewer. The content 1400, such as the example shown in FIG. 14A, may be recorded with a 3D or 360-degree camera setup. FIG. 14A shows a 360-degree view 1402 of a room of computers.

FIG. 14B is a schematic perspective view illustrating an example director's decision for the main display view of an immersive video according to some embodiments. The content creator (or director) may select a view of the content for the presentation. In some embodiments, the director creates a 2D presentation by setting rendering constraints for the media player. For example, a time series database may be created with coordinates and image size information for each time frame. FIG. 14B is a subset of the 360-degree video content shown in FIG. 14A. The director's main display view shown in FIG. 14B is a resized image 1450 of the video content outlined with a rectangle 1404 in FIG. 14A.

For some embodiments, the viewer may be presented with an option to explore the content more freely within a multi-device environment. By connecting a tablet (or other connected device) to the main display (which may be a smart TV, for example), the viewer may be able to view content in different directions. In some embodiments, the tablet (or other connected device) synchronizes the stream with the main display (which may be done using a back-facing camera pointed towards the video presentation on the main display). This action enables both temporal and spatial synchronization of the multi-device environment.

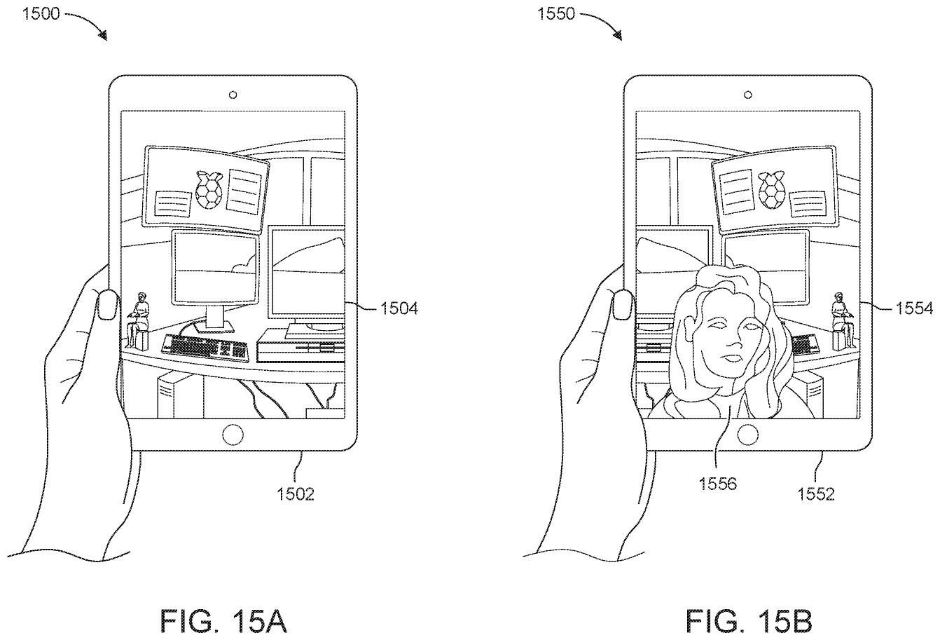

FIG. 15A is a schematic perspective view illustrating an example device used to explore an immersive video environment according to some embodiments. FIG. 15B is a schematic perspective view illustrating an example device used with a virtual mirror view of immersive video content according to some embodiments. The example connected device of FIGS. 15A and 15B is a tablet 1502, 1552, though other devices, such as a smart phone, may be used to explore an immersive video.

A front-facing camera may capture an image of the user and may overlay the image on top of the presentation. The viewer may see herself 1556 as she would in a physical mirror. The background may be taken from the 360-degree stream. The user may experience the environment as being within the presentation. For some embodiments, FIG. 15A may have a center compass heading indicating a location behind the user, and FIG. 15B may have a center compass heading indicating a location in front of the user. For some embodiments, a virtual mirror view may show a reflection of content associated with a location behind the user. Hence, the background content 1554 of FIG. 15B is a mirror reflection of the content 1504 shown in FIG. 15A. In FIG. 15B, the user has turned 180 degrees compared to FIG. 15A such that the content 1554 in FIG. 15B is a mirror image of the content 1504 in FIG. 15A, and the content 1554 in FIG. 15B appears behind the user 1556.

For some embodiments, an image from a front-facing camera of a mobile device may be recorded to generate a recorded image. The recorded image may be overlaid on a viewport to generate an updated viewport. Displaying a viewport may include displaying the updated viewport. In some embodiments, the recorded image may be displayed as an overlay over a viewport. For some embodiments, a viewport of an immersive video may include a virtual mirror of another viewport of the immersive video.

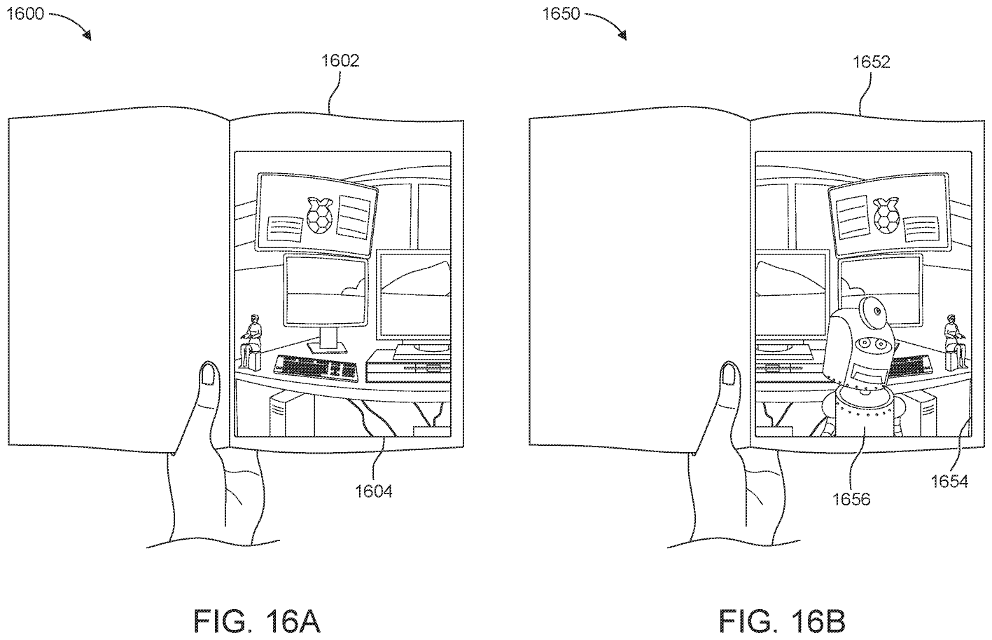

FIG. 16A is a schematic perspective view illustrating an example AR view displaying a virtual mirror of immersive video content located behind a user according to some embodiments. FIG. 16B is a schematic perspective view illustrating an example AR view displaying immersive video content overlaid with an avatar according to some embodiments.

In some embodiments, in an AR environment, a mirror view mode may implemented with a mobile device displaying a virtual mirror. The user sees the mirror in the AR view and may follow the presentation displayed on the virtual mirror. The presentations displayed on the virtual mirrors 1604, 1654 of FIGS. 16A and 16B are presented to appear similar to the content displayed on the tablets 1502, 1552 of FIGS. 15A and 15B. For some embodiments, an avatar 1656 (e.g., an AR image of a robot is shown as an example in FIG. 16B) of the user may be used with a wearable AR headset. The position of the wearable AR headset (and thereby the position of the user) relative to the artificial object (or artificial mirror) is determined. The rendering of the avatar 1656 may be altered using this relative position. FIG. 16A shows an example of an AR view displaying a book 1602 with a virtual mirror 1604 of immersive (e.g., 360-degree) video content located behind a user according to some embodiments. FIG. 16B shows an example of an AR view displaying a book 1652 with a virtual mirror displaying immersive (e.g., 360-degree) video content overlaid with an avatar 1656 according to some embodiments. In the example shown in FIG. 16B in accordance with some embodiments, the avatar 1656 representing the user reflects that the users perspective has turned 180 degrees compared to FIG. 16A such that the content 1654 in FIG. 16B is a mirror image of the content 1604 in FIG. 16A, and the content 1654 appears behind the avatar 1656 representing the user.

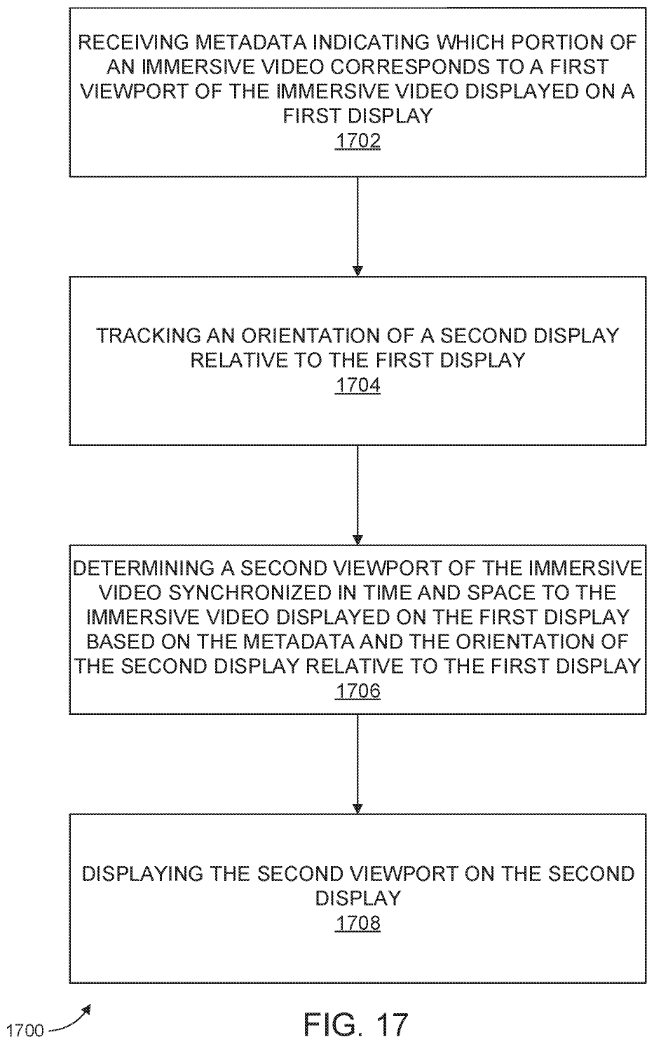

FIG. 17 is a flowchart illustrating an example process according to some embodiments. In some embodiments, a process 1700 may include receiving 1702 metadata indicating which portion of an immersive video corresponds to a first viewport of the immersive video displayed on a first display. The process 1700 may further include tracking 1704 an orientation of a second display relative to the first display. Some embodiments of the process 1700 may include determining 1706 a second viewport of the immersive video synchronized in time and space to the immersive video displayed on the first display based on the metadata and the orientation of the second display relative to the first display. In some embodiments, the process 1700 may include displaying 1708 the second viewport on the second display. In some embodiments, an apparatus may include a processor and a non-transitory computer-readable medium storing instructions that are operative, when executed by the processor, to perform a process disclosed herein, such as the process 1700 shown in FIG. 17. In some embodiments, immersive video may include 360-degree video.

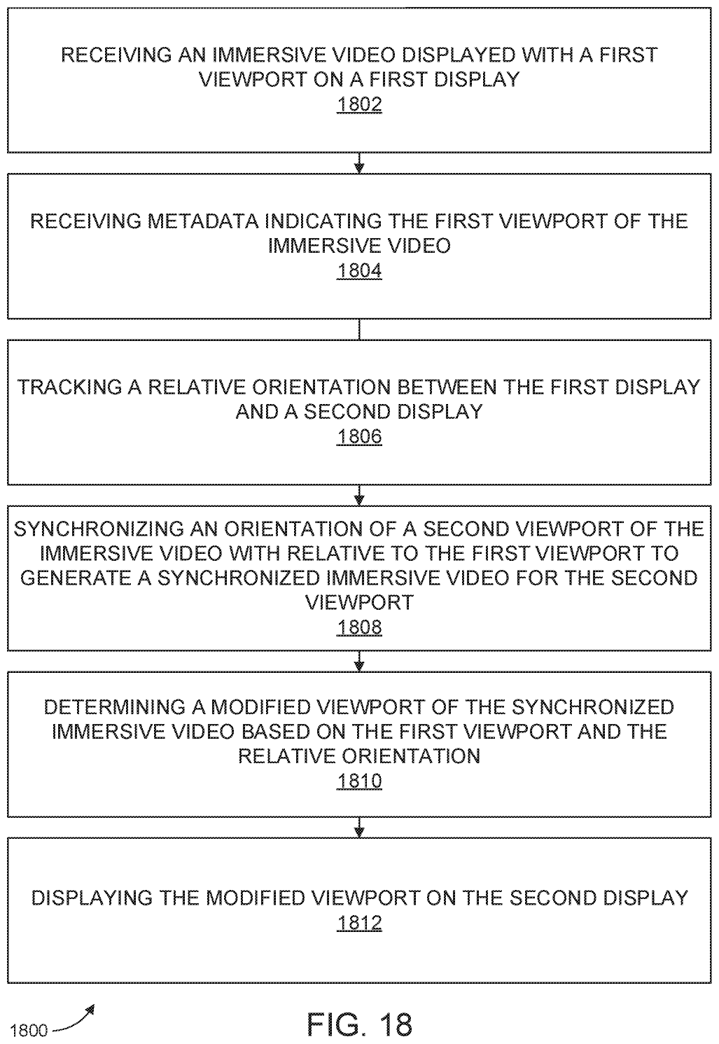

FIG. 18 is a flowchart illustrating an example process according to some embodiments. In some embodiments, a process 1800 may include receiving 1802 an immersive video displayed with a first viewport on a first display. Some embodiments of the process 1800 may further include receiving 1804 metadata indicating the first viewport of the immersive video. In some embodiments, the process 1800 may include tracking 1806 a relative orientation between the first display and a second display. Some embodiments of the process 1800 may further include synchronizing 1808 an orientation of a second viewport of the immersive video relative to the first viewport to generate a synchronized immersive video for the second viewport. In some embodiments, the process 1800 may include determining 1810 a modified viewport of the synchronized immersive video based on the first viewport and the relative orientation. Some embodiments of the process 1800 may further include displaying 1812 the modified viewport on the second display. In some embodiments, an apparatus may include a processor and a non-transitory computer-readable medium storing instructions that are operative, when executed by the processor, to perform a process disclosed herein, such as the process 1800 shown in FIG. 18.

For some embodiments, an example process executed by a device may include receiving metadata indicating which portion of a 360-degree video content corresponds to a first viewport of the 360-degree video content displayed on a fixed display. The example process may include tracking an orientation of a mobile device relative to the fixed display. The example process may further include determining a second viewport of the 360-degree video content synchronized in time and space to the 360-degree video content displayed on the fixed display based on the metadata and the orientation of the mobile device relative to the fixed display. The example process may also include displaying the second viewport on the mobile device.

For some embodiments, a second example process executed by a device may include receiving an immersive video displayed with a first viewport on a first display. The second example process may include receiving metadata indicating the first viewport of the immersive video. The second example process may further include tracking a relative orientation between the first display and a second display. The second example process may include synchronizing a second viewport of the immersive video with the first viewport to generate a synchronized immersive video. The second example process may include determining a modified viewport of the synchronized immersive video based on the first viewport and the relative orientation. For example, the first viewport may be re-oriented using the relative orientation to generate the modified viewport. Such a re-orienting may be performed using Eq. 1 described in relation to FIGS. 9A-9C. the second example process may further include displaying the modified viewport on a second display. For some embodiments, an apparatus or device may include a processor and a non-transitory computer-readable medium storing instructions that are operative, when executed by the processor, to perform any of the methods described above.

For some embodiments, methods and systems may be performed in the contexts of virtual reality (VR), mixed reality (MR), or augmented reality (AR). For some embodiments, a head mounted display (HMD) may be used to display a VR, MR, or AR environment, or, e.g., any combination of these. For some embodiments, a wearable device (which may or may not be attached to the head of a user) may be used to display a viewport of a 360-degree video or immersive video.

An example method in accordance with some embodiments may include: receiving metadata indicating which portion of a 360-degree video corresponds to a first viewport of the 360-degree video displayed on a fixed display; tracking an orientation of a mobile device relative to the fixed display; determining a second viewport of the 360-degree video synchronized in time and orientation relative to the 360-degree video displayed on the fixed display based on the metadata and the orientation of the mobile device relative to the fixed display; and displaying the second viewport on the mobile device.

In some embodiments of the example method, determining the second viewport may include: determining a first angle from the orientation of the mobile device relative to the fixed display; determining a second angle from a center of the first viewport of the 360-degree video displayed on the fixed display; and orienting, for the second angle, the 360-degree video synchronized in time and space to generate the second viewport.

In some embodiments of the example method, determining the second viewport of the 360-degree video may include determining a virtual mirror viewport of the 360-degree video.

In some embodiments of the example method, determining the second viewport of the 360-degree video may include selecting a location of a virtual mirror corresponding to a portion of the 360-degree video displayed on the fixed display.

In some embodiments of the example method, displaying the second viewport of the 360-degree video may include rendering a portion of the 360-degree video corresponding to the location of the virtual mirror.

Some embodiments of the example method may further include: recording an image from a front-facing camera of a mobile device to generate a recorded image; and overlaying the recorded image on the second viewport to generate an updated second viewport, wherein displaying the second viewport displays the updated second viewport.

Some embodiments of the example method may further include: recording an image from a front-facing camera of a mobile device to generate a recorded image; and displaying the recorded image as an overlay over the second viewport on the mobile device.

In some embodiments of the example method, the second viewport is a virtual mirror of the first viewport.

Some embodiments of the example method may further include: selecting an object within the second viewport of the 360-degree video as a virtual mirror object, wherein displaying the second viewport may include replacing the virtual mirror object with a portion of the first viewport of the 360-degree video.

Some embodiments of the example method may further include: selecting an object within the 360-degree video as a virtual mirror object; and replacing the virtual mirror object with a portion of the first viewport of the 360-degree video, wherein displaying the second viewport may include displaying the virtual mirror object replaced with the portion of the first viewport of the 360-degree video.

In some embodiments of the example method, the second viewport is a virtual mirror of the first viewport.

Some embodiments of the example method may further include: recording an image from a front-facing camera of a mobile device to generate a recorded image; determining a boundary of a user in the recorded image to generate a shape of the user; cropping the recorded image by tracing the shape of the user to generate a cropped image; and displaying the cropped image as an overlay over the second viewport on the mobile device.

In some embodiments of the example method, determining the second viewport of the 360-degree video may include: capturing an image of the 360-degree video displayed on the fixed display to generate a captured image; determining a first time instant that the captured image is captured; determining a second time instant that a first portion of the 360-degree video corresponding to the captured image is displayed; determining a time delay as the difference between the first time instant and the second time instant; time-adjusting the second viewport based on the time delay to generate a time-adjusted viewport; and displaying the time-adjusted viewport on the mobile device.

In some embodiments of the example method, tracking the orientation of the mobile device relative to the fixed display may include: determining a first direction of the mobile device when the fixed display is parallel to the mobile device at a first time; determining a second direction of the mobile device at a second time; determining a heading difference between the first direction and the second direction; and storing the heading difference as the orientation of the mobile device relative to the fixed display.

In some embodiments of the example method, tracking the orientation of the mobile device relative to the fixed display may include: determining a first direction of the mobile device relative to the fixed display at a first time; determining a second direction of the mobile device relative to the fixed display at a second time; determining a heading difference between the first direction and the second direction; and storing the heading difference as the orientation of the mobile device relative to the fixed display.

In some embodiments of the example method, metadata may include a media presentation description file.

An example apparatus in accordance with some embodiments may include: a processor; and a non-transitory computer-readable medium storing instructions that are operative, when executed by the processor, to perform any of the methods listed above.

Another example method in accordance with some embodiments may include: receiving an immersive video displayed with a first viewport on a first display; receiving metadata indicating the first viewport of the immersive video; tracking a relative orientation between the first display and a second display; synchronizing an orientation of a second viewport of the immersive video relative to the first viewport to generate a synchronized immersive video for the second viewport; determining a modified viewport of the synchronized immersive video based on the first viewport and the relative orientation; and displaying the modified viewport on the second display.

In some embodiments of the example method, tracking the relative orientation between the first display and the second display may include: determining a first direction of the second display relative to the first display at a first time; determining a second direction of the second display relative to the first display at a second time; determining a heading difference between the first direction and the second direction; and storing the heading difference as the relative orientation between the first display and the second display.

In some embodiments of the example method, determining the modified viewport of the immersive video may include selecting a location of a virtual mirror corresponding to a portion of the immersive video displayed on the first display.

In some embodiments of the example method, displaying the modified viewport of the immersive video may include rendering the portion of the immersive video corresponding to the location of the virtual mirror.

An example apparatus in accordance with some embodiments may include: a processor; and a non-transitory computer-readable medium storing instructions that are operative, when executed by the processor, to perform any of the methods listed above.

A further example method in accordance with some embodiments may include: receiving metadata indicating which portion of an immersive video corresponds to a first viewport of the immersive video displayed on a first display; tracking an orientation of a second display relative to the first display; determining a second viewport of the immersive video synchronized in time and orientation relative to the immersive video displayed on the first display based on the metadata and the orientation of the second display relative to the first display; and displaying the second viewport on the second display.

An example apparatus in accordance with some embodiments may include: a processor; and a non-transitory computer-readable medium storing instructions that are operative, when executed by the processor, to perform any of the methods listed above.

An example method in accordance with some embodiments may include: receiving an immersive video associated with content shown on a first display; time-synchronizing the immersive video shown on a second display with the content shown on the first display to generate a time-synchronized immersive video; tracking a relative orientation between the first display and the second display; receiving metadata indicating a first viewport of the time-synchronized immersive video; determining a modified viewport of the time-synchronized immersive video based on the first viewport and the relative orientation; and displaying, on the second display, the modified viewport.

For some embodiments of the example method, metadata may indicate a position of the first viewport within the time-synchronized immersive video as a function of time.

Some embodiments of a method may further include spatially-synchronizing the immersive video shown on the second display with the content shown on the first display.

For some embodiments, determining the modified viewport may include: determining a first angle from the relative orientation between the first display and the second display; determining a second angle from a center of the first viewport and a north direction of the content shown on the first display; determining a modified angle as a difference of the first angle and the second angle; and determining the modified viewport by orienting the time-synchronized immersive video for the modified angle.

Some embodiments of a method may further include: determining a virtual mirror viewport of the time-synchronized immersive video to generate a reflected immersive video, wherein determining the modified viewport determines a viewport of the reflected immersive video.

For some embodiments, determining the virtual mirror viewport may include: recording an image from a front-facing camera of a mobile device to generate a recorded image; overlaying the recorded image on the modified viewport to generate a composite image; and displaying, on the second display, the composite image.

Some embodiments of a method may further include: determining a boundary of a user in the recorded image to generate a shape of the user; and cropping the recorded image by tracing the shape of the user to generate a cropped image, wherein overlaying the recorded image on the modified viewport overlays the cropped image on the modified viewport.

For some embodiments, time-synchronizing the immersive video may include: capturing an image of the content shown on the first display to generate a captured image; determining a first time instant the captured image is captured; determining a second time instant a first portion of the immersive video corresponding to the captured image is displayed; determining a time delay as the difference between the first time instant and the second time instant; and time-adjusting displaying, on the second display, the modified viewport based on the time delay.

For some embodiments, tracking the relative orientation between the first display and the second display may include: determining a first compass heading of the second display for a condition where the first display is parallel to the second display at a time t1; determining a second compass heading of the second display at a time t2; determining a heading difference between the first compass heading and the second compass heading; and storing the heading difference to track the relative orientation between the first display and the second display.

Some embodiments of a method may include: receiving an immersive video associated with content shown on a first display; time-synchronizing the immersive video shown on a second display with the content shown on the first display to generate a time-synchronized immersive video; selecting a location for a virtual mirror corresponding to a portion of the time-synchronized immersive video shown on the second display; rendering a modified viewport of the time-synchronized immersive video, which may include: rendering a virtual mirror viewport of the time-synchronized immersive video, and rendering a modified viewport of the time-synchronized immersive video, wherein the virtual mirror viewport of the time-synchronized immersive video is used for rendering a portion of the time-synchronized immersive video corresponding to the virtual location of the virtual mirror; and displaying, on the second display, the modified viewport.

Some embodiments of a method may further include spatially-synchronizing the immersive video shown on the second display with the content shown on the first display.

Some embodiments of a method may further include: tracking a relative orientation between the first display and the second display; receiving metadata indicating a first viewport of the time-synchronized immersive video; and determining a modified viewport of the time-synchronized immersive video based on the first viewport and the relative orientation.

For some embodiments, metadata may indicate a position of the first viewport within the time-synchronized immersive video as a function of time.

For some embodiments, determining the modified viewport may include: determining a first angle from the relative orientation between the first display and the second display; determining a second angle from a center of the first viewport and a north direction of the content shown on the first display; determining a modified angle as a difference of the first angle and the second angle; and determining the modified viewport by orienting the time-synchronized immersive video for the modified angle.

For some embodiments, rendering a virtual mirror viewport of the time-synchronized immersive video may include determining a virtual mirror viewport of the time-synchronized immersive video to generate a reflected immersive video, wherein rendering the modified viewport determines a viewport of the reflected immersive video.

For some embodiments, determining the virtual mirror viewport may include: recording an image from a front-facing camera of a mobile device to generate a recorded image; overlaying the recorded image on the modified viewport to generate a composite image; and displaying, on the second display, the composite image.

Some embodiments of a method may further include: determining a boundary of a user in the recorded image to generate a shape of the user; and cropping the recorded image by tracing the shape of the user to generate a cropped image, wherein overlaying the recorded image on the modified viewport overlays the cropped image on the modified viewport.

For some embodiments, time-synchronizing the immersive video may include: capturing an image of the content shown on the first display to generate a captured image; determining a first time instant the captured image is captured; determining a second time instant a first portion of the immersive video corresponding to the captured image is displayed; determining a time delay as the difference between the first time instant and the second time instant; and time-adjusting displaying, on the second display, the modified viewport based on the time delay.

For some embodiments, tracking the relative orientation between the first display and the second display may include: determining a first compass heading of the second display for a condition where the first display is parallel to the second display at a first time (e.g., a time t1); determining a second compass heading of the second display at a second time (e.g. a time t2); determining a heading difference between the first compass heading and the second compass heading; and storing the heading difference to track the relative orientation between the first display and the second display.

Some embodiments of a device may include: a position sensor; a processor; and a non-transitory computer-readable medium storing instructions that are operative, if executed on the processor, to perform the processes of: receiving an immersive video associated with content shown on a first display; time-synchronizing the immersive video shown on a second display with the content shown on the first display to generate a time-synchronized immersive video; tracking a relative orientation between the first display and the second display; receiving metadata indicating a first viewport of the time-synchronized immersive video; determining a modified viewport of the time-synchronized immersive video based on the first viewport and the relative orientation; and displaying, on the second display, the modified viewport.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
receiving metadata indicating which portion of a 360-degree video corresponds to a first viewport of the 360-degree video displayed on a fixed display;
tracking an orientation of a mobile device relative to the fixed display;
determining a second viewport of the 360-degree video synchronized in time and orientation relative to the 360-degree video displayed on the fixed display based on the metadata and the orientation of the mobile device relative to the fixed display; and
displaying the second viewport on the mobile device.

2. The method of claim 1, wherein determining the second viewport comprises:
determining a first angle from the orientation of the mobile device relative to the fixed display;
determining a second angle from a center of the first viewport of the 360-degree video displayed on the fixed display; and
orienting, for the second angle, the 360-degree video synchronized in time and space to generate the second viewport.

3. The method of claim 1, wherein determining the second viewport of the 360-degree video comprises determining a virtual mirror viewport of the 360-degree video.

4. The method of claim 1, wherein determining the second viewport of the 360-degree video comprises selecting a location of a virtual mirror corresponding to a portion of the 360-degree video displayed on the fixed display.

5. The method of claim 4, wherein displaying the second viewport of the 360-degree video comprises rendering a portion of the 360-degree video corresponding to the location of the virtual mirror.

6. The method of claim 1, further comprising:
recording an image from a front-facing camera of a mobile device to generate a recorded image; and
overlaying the recorded image on the second viewport to generate an updated second viewport,
wherein displaying the second viewport displays the updated second viewport.

7. The method of claim 1, further comprising:
recording an image from a front-facing camera of a mobile device to generate a recorded image; and
displaying the recorded image as an overlay over the second viewport on the mobile device.

8. The method of claim 7, wherein the second viewport is a virtual mirror of the first viewport.

9. The method of claim 1, further comprising:
selecting an object within the second viewport of the 360-degree video as a virtual mirror object,
wherein displaying the second viewport comprises replacing the virtual mirror object with a portion of the first viewport of the 360-degree video.

10. The method of claim 1, further comprising:
selecting an object within the 360-degree video as a virtual mirror object; and
replacing the virtual mirror object with a portion of the first viewport of the 360-degree video,
wherein displaying the second viewport comprises displaying the virtual mirror object replaced with the portion of the first viewport of the 360-degree video.

11. The method of claim 1, wherein the second viewport is a virtual mirror of the first viewport.

12. The method of claim 1, further comprising:
recording an image from a front-facing camera of a mobile device to generate a recorded image;
determining a boundary of a user in the recorded image to generate a shape of the user;
cropping the recorded image by tracing the shape of the user to generate a cropped image; and
displaying the cropped image as an overlay over the second viewport on the mobile device.

13. The method of claim 1, wherein determining the second viewport of the 360-degree video comprises:
capturing an image of the 360-degree video displayed on the fixed display to generate a captured image;
determining a first time instant that the captured image is captured;
determining a second time instant that a first portion of the 360-degree video corresponding to the captured image is displayed;
determining a time delay as the difference between the first time instant and the second time instant;
time-adjusting the second viewport based on the time delay to generate a time-adjusted viewport; and
displaying the time-adjusted viewport on the mobile device.

14. The method of claim 1, wherein tracking the orientation of the mobile device relative to the fixed display comprises:
determining a first direction of the mobile device when the fixed display is parallel to the mobile device at a first time;
determining a second direction of the mobile device at a second time;
determining a heading difference between the first direction and the second direction; and
storing the heading difference as the orientation of the mobile device relative to the fixed display.

15. The method of claim 1, wherein tracking the orientation of the mobile device relative to the fixed display comprises:
determining a first direction of the mobile device relative to the fixed display at a first time;
determining a second direction of the mobile device relative to the fixed display at a second time;
determining a heading difference between the first direction and the second direction; and
storing the heading difference as the orientation of the mobile device relative to the fixed display.

16. The method of claim 1, wherein the metadata comprises a media presentation description file.

17. The method of claim 1, wherein the metadata indicates a change in spatial location of the first viewport of the 360-degree video.

18. The method of claim 1, wherein receiving metadata indicating which portion of the 360-degree video corresponds to the first viewport of the 360-degree video displayed on the fixed display further comprises receiving metadata indicating the extent to which the portion of the 360-degree video corresponding to the first viewport of the 360-degree video is changing with time.

19. An apparatus comprising:
a processor; and
a non-transitory computer-readable medium storing instructions that are operative, when executed by the processor, cause the apparatus to:
receive metadata indicating which portion of a 360-degree video corresponds to a first viewport of the 360-degree video displayed on a fixed display;
track an orientation of a mobile device relative to the fixed display;
determine a second viewport of the 360-degree video synchronized in time and orientation relative to the 360-degree video displayed on the fixed display based on the metadata and the orientation of the mobile device relative to the fixed display; and
display the second viewport on the mobile device.

20. A method comprising:
receiving an immersive video displayed with a first viewport on a first display;
receiving metadata indicating the first viewport of the immersive video;
tracking a relative orientation between the first display and a second display;
synchronizing an orientation of a second viewport of the immersive video relative to the first viewport to generate a synchronized immersive video for the second viewport;
determining a modified viewport of the synchronized immersive video based on the first viewport and the relative orientation; and
displaying the modified viewport on the second display.

21-26. (canceled)
